(19) United States
(12) Patent Application Publication
(10) Pub. No.: US 2022/0237072 A1
(43) Pub. Date: Jul. 28, 2022

(54) HIERARCHICAL FAILURE RECOVERY FOR A NETWORK-BASED SERVICE USING STATECHART OBJECTS

(71) Applicant: Uber Technologies, Inc., San Francisco, CA (US)

(72) Inventors: Uday Kiran Medisetty, San Francisco, CA (US); Ankit Srivastava, San Francisco, CA (US); Madan Thangavelu, San Francisco, CA (US); Jahan Cherian, San Francisco, CA (US); Wenting Wang, San Francisco, CA (US); Kamran Massoudi, San Francisco, CA (US); Emad Khan, San Francisco, CA (US)

(21) Appl. No.: 17/318,874

(22) Filed: May 12, 2021

Related U.S. Application Data
(60) Provisional application No. 63/142,834, filed on Jan. 28, 2021.

(51) Int. Cl. G06F 11/07; G06Q 10/06; H04L 29/08

(52) U.S. Cl. CPC G06F 11/0793; G06F 11/0709; H04L 67/32; G06F 11/0772; G06Q 10/0631; G06F 11/0751

(57) ABSTRACT

Various aspects of a requested transport or delivery service can be modelled and computationally represented using different classes of statechart objects. Some of the statechart objects can be transitioned between one or more composite states each having a plurality of substates. In this manner, delays, errors, and failures relating to the transport or delivery service can be tracked using state transitions of the statechart objects. And dynamic recovery functions to such delays, errors, and failures can be performed in response.

### CROSS-REFERENCE TO RELATED APPLICATIONS

This application claims the benefit of Provisional U.S. Application Ser. No. 63/142,834, filed Jan. 28, 2021, titled “MODELING PROVISIONING OF NETWORK-BASED SERVICES USING STATECHARTS”; the aforementioned priority application being hereby incorporated by reference in its entirety.

### BACKGROUND

A network-based service can enable users to request and receive various services through applications executing on computing devices such as mobile phones, tablets, personal computers, and the like. The network-based service can match a service provider with a requesting user based on the current location of the service provider and a start location specified by the requesting user or determined based on the current location of the requesting user.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1A is a block diagram illustrating an example network system configured to implement statecharts in fulfilling a network service, in accordance with examples described herein;

FIG. 1B is a block diagram illustrating the storage of data relating to statechart objects, in accordance with examples described herein;

FIG. 2A to 2C illustrate example statechart objects associated with a user's requests for service, in accordance with examples described herein;

FIGS. 3A to 3C illustrate exemplary states and state transitions of statechart objects, in accordance with examples described herein;

FIGS. 4A to 4D are flowchart diagrams illustrating example methods of instantiating and managing statechart objects in response to detected triggers or events, in accordance with examples described herein;

FIG. 4E is a flowchart diagram illustrating an example method of detecting failures, errors, or delays and performing one or more recovery actions based on state transitions of a statechart object, in accordance with examples described herein;

FIG. 4F is a flowchart diagram illustrating an example method of performing one or more recovery actions using linked statechart objects;

FIG. 5 is a block diagram illustrating an example service provider device executing and operating a designated service provider application for communicating with a network service, according to examples described herein;

FIG. 6 is a block diagram illustrating an example user device executing and operating a designated user application for communicating with a network system, as described herein; and

FIG. 7 is a block diagram illustrating a computer system upon which examples described herein may be implemented.

### DETAILED DESCRIPTION

A network system is provided herein that manages an on-demand network-based service linking available service providers with service requesters throughout a given region (e.g., a metroplex such as the San Francisco Bay Area). In doing so, the network system can receive service requests for on-demand services (e.g., transport service, delivery service, micro-mobility ser) from requesting users (e.g., a rider) via a designated service requester application executing on the users' mobile computing devices. Based on a service location, the network system can identify a number of proximate available service providers (e.g., a driver) and transmit a service invitation to one or more service provider devices of the proximate available service providers to fulfil the service request. In many examples, the service providers can either accept or decline the invitation based on, for example, the service location being impractical for the service provider.

In selecting a service provider to fulfill a given service request, the network system can identify a service provider based, at least in part, on a start location indicated in the service request. For example, the network system can determine a geo-fence surrounding the start location (or a geo-fence defined by a radius away from the start location), identify a set of candidate service providers (e.g., twenty or thirty service providers within the geo-fence), and select an optimal service provider (e.g., closest service provider to the service location, service provider with the shortest estimated travel time from the service location, service provider traveling to a location within a specified distance or specified travel time to the destination location, etc.) from the candidate service providers to fulfill the service request. According to examples provided herein, the network system can compile historical data for individual service requesters with regard to the network-based service. Thus, the network system can manage a service requester profile for each service requester indicating routine start and/or end locations (or regions), and/or routine routes (e.g., for a transportation service from home to work and/or vice versa) and preferred service types (e.g., transportation, delivery, mailing, etc.). In some examples, the network system can further synchronize with a service requester device to, for example, identify the service requester's contacts, the service requester's schedule and appointments, travel plans (e.g., a scheduled trip), and the like.

According to embodiments, the network system is configured to model various aspects of fulfilling users' requests for network-based services (e.g., transport services, delivery services, etc.) using statecharts. A statechart is a hierarchical computational representation of a state machine. In contrast with conventional finite state machines (FSMs), a statechart can have nested or hierarchical states where each state in the statechart can include subordinate states or substates (and those subordinate states can include their own substates). The network system can instantiate a plurality of statechart object types or classes, with each statechart object type being used to model a particular aspect of processing and fulfilling the users' requests. For instance, to model the fulfillment cycle of a user's request for service, the network system can instantiate a fulfillment order statechart object. To model a point-to-point transport job for transporting the user or for transporting one or more items for delivery to the user, the network system can use a transport job statechart object. An offer statechart object can be used to model an offer or an invitation to a transport service provider to fulfill the request. A waypoint statechart object can be used to model the transport service provider's progress towards a location (e.g., a start location specified by the user) and/or progress in completing one or more tasks at the location (e.g., picking up the user at the start location). The users and transport service providers can also be modelled using statechart objects. As used herein, a statechart object instantiated by the network system to represent one or more aspects of the network service can be referred to as a statechart. Thus “statechart objects” and “statecharts” may be used interchangeably.

In various implementations, as statuses and conditions relating to the fulfillment of the user's request change and as events relating to the service request occur, the statecharts can be triggered to transition to a different state. These can be referred to herein as statechart state transitions or statechart transitions. A statechart can be triggered to transition states in response to a trigger or a detected event, such as receiving a user or transport service provider input via their respective service applications. The network system can also monitor certain events to trigger the instantiation of one or more statechart objects. As one example, receiving a request for service can trigger the instantiation of a fulfillment order statechart object and that fulfillment order statechart object can be used to model the fulfillment cycle of the received request. The statecharts can also be linked to one another such that a statechart transition of one statechart object can trigger one or more other statechart transitions of other linked statechart objects. In addition, the linking of statechart objects can be dynamic. In other words, links and associations between statechart objects are not predetermined or predefined—statechart objects can be linked at time of instantiation of the statechart objects or after instantiation in response to detected events or triggers or in response to other statechart transitions. In this manner, through the use of dynamically linked hierarchical statecharts, the computational constructs used to model the fulfillment of the users' requests can be scaled up or down as the situations require or demand. The result is a flexible computational architecture that is capable of modelling a vast array of possible situations and statuses without making the basic building blocks of the architecture itself too cumbersome to develop and implement.

According to embodiments, data relating to the statechart objects, including their current states, can be written to one or more databases for persistent storage. Such data may need to be written to persistent storage for logging purposes, for system integrity considerations (e.g., to recovery from a server shut down, a power loss, a memory corruption, etc.), and for access by other components of the system that need to retrieve data relating to the statechart objects. To preserve data consistency such that inconsistent data are not written to persistent storage, the network system can include a transaction coordinator to monitor whether each of a set of related statechart transactions (e.g., a set of statechart transactions that are trigger or performed in response to a detected event) is successfully completed before committing such data to persistent storage. If at least one of the set of related statechart transitions is not successfully performed, the transaction coordinator can determine not to commit any data to persistent storage, roll back the other statechart transitions, and cause the network system to perform one or more recovery actions (depending on the particular failure).

In contrast to the embodiments described herein, conventional systems use FSMs to represent aspects of a transport service or a delivery service. In these conventional systems, the state transitions of FSMs are predefined or predetermined and adding or modifying aspects of the service being represented by the FSMs quickly add complexities in coding the FSM transitions. In contrast with this conventional approach, embodiments described herein can utilize statechart objects that can be implemented as one or more microservices and are dynamically linked to one another at runtime and/or at time of instantiation. Rather using than static FSM state transition diagrams, dynamically linked statecharts can pass state transition information and other data to one another. A first statechart object can be dynamically linked to a second statechart object at runtime and during the modelling of the transport or delivery service, a transition in the state of the first statechart object can cause or trigger a transition in the state of the second statechart object. In this manner, the framework of modelling the various aspects of the transport or delivery service is made much more flexible and scalable. For example, dependencies between statechart objects can be dynamically updated and determined at runtime without the need to re-program or re-code the FSM state frameworks.

Another disadvantage of conventional systems using FSMs to represent aspects of transport or delivery services is the complexity and shortcomings in ensuring data integrity and ACID (atomicity, consistency, isolation, and durability) compliance in storing data relating to services. In particular, state transitions of FSMs can fail for a variety of reasons such as power failure at the data storage level, data inconsistency in the FSMs, etc. In such cases, ensuring data integrity in a complex system modelled by individual FSMs can be a tremendous challenge. In contrast, embodiments described herein provide for dynamically linked statechart objects that each maintain a degree of atomicity. A transaction coordinator can identify, based on the dynamic links between the statechart objects, a set of state transitions of various statechart objects that are to be performed and if any of the set of state transitions fail or return an error, the other state transitions can be immediately rolled back. In this manner, the states of various linked statechart objects are not out of sync. Moreover, the transaction coordinator can ensure that data representing a particular transaction or data representing the processing of a detected event is stored in the databases (e.g., in data tables corresponding to the statechart objects) only if each of the set of state transitions is successfully completed.

Furthermore, by using linked statechart objects to model and represent various aspects of the network-based service, failures, delays, or errors (collectively referred to herein as failures) in fulfilling the service for the requesting user can be monitored and managed based on the statechart objects. In particular, different classes or types of statechart objects can be used to track different types of failures within the fulfillment cycle of a user's request. A statechart object class or type used to represent a particular aspect of the fulfillment cycle can be used to track failures that are relevant to that particular aspect of the fulfillment cycle. For example, a waypoint statechart object that represents a geographic location (e.g., a pick-up location, a drop-off location, etc.) can be used to monitor the progress of a service provider in performing one or more tasks with respect to the geographic location (e.g., navigating to the location, picking up or dropping off the requesting user at the location, dropping off the user at the location, picking up or dropping off items for delivery at the location, etc.) and detect failures in the service provider in performing such tasks. As another example, transport job statechart objects that represent a transport job provided by a service provider from a first location to a second location can be used to monitor and detect failures in, for instance, identifying a matching service provider for the request of the user. In this manner, the failures can be monitored and tracked at the appropriate level within the hierarchical computational framework provided by use of the linked statechart objects for modelling the fulfillment cycle of the user's request for service.

In addition, because the statechart objects are dynamically linked, information pertaining to a detected failure can be relayed to a different level within the hierarchical computational architecture (e.g., to a linked statechart object). For instance, information pertaining to a failure detected with respect to a waypoint statechart object can be relayed to a linked transport statechart object which can in turn relay the information to a linked fulfillment order statechart object. Information that can be conveyed between linked statechart objects can include a failure type, time of the detected failure, a delay or deviation from an expected time, etc. Furthermore, the network system can recover from detected failures using the hierarchical computational architecture of the linked statechart objects. For instance, the network system can be triggered to perform one or more recovery actions in response to a state transition of a statechart object. As one example, a waypoint statechart object transitioning to a critical substate can trigger the performance of one or more recovery actions associated with a transport job statechart object that is linked to the waypoint statechart object.

As used herein, the terms “optimize,” “optimization,” “optimizing,” and the like are not intended to be restricted or limited to processes that achieve the most optimal outcomes. Rather, these terms encompass technological processes (e.g., heuristics, stochastics modelling, machine learning, reinforced learning, Monte Carlo methods, Markov decision processes, etc.) that aim to achieve desirable results. Similarly, terms such as “minimize” and “maximize” are not intended to be restricted or limited to processes or results that achieve the absolute minimum or absolute maximum possible values of a metric, parameter, or variable.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Descriptions

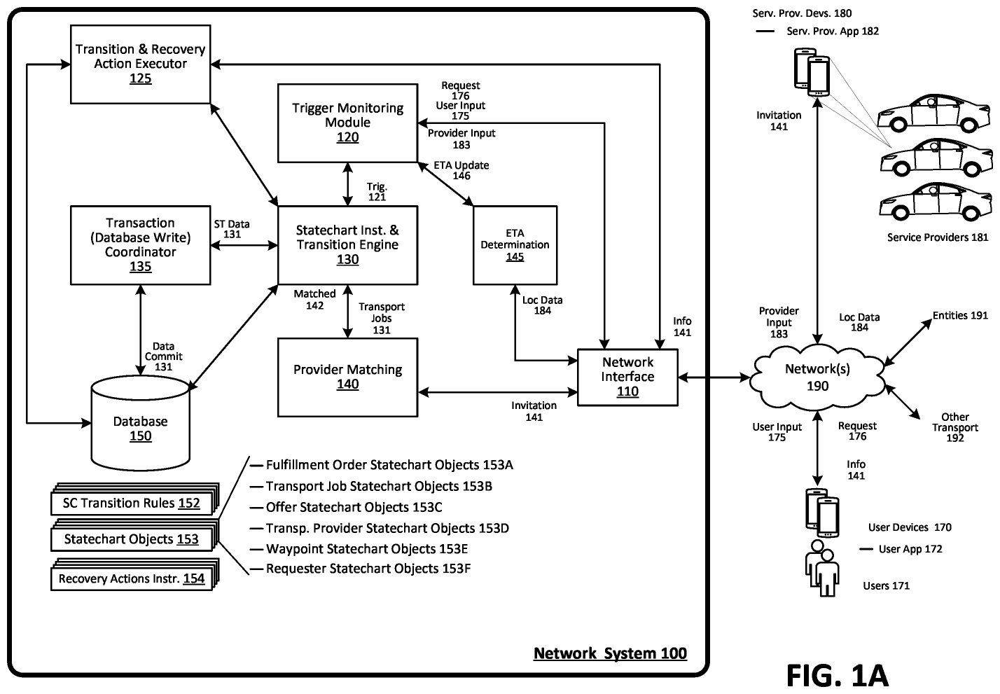

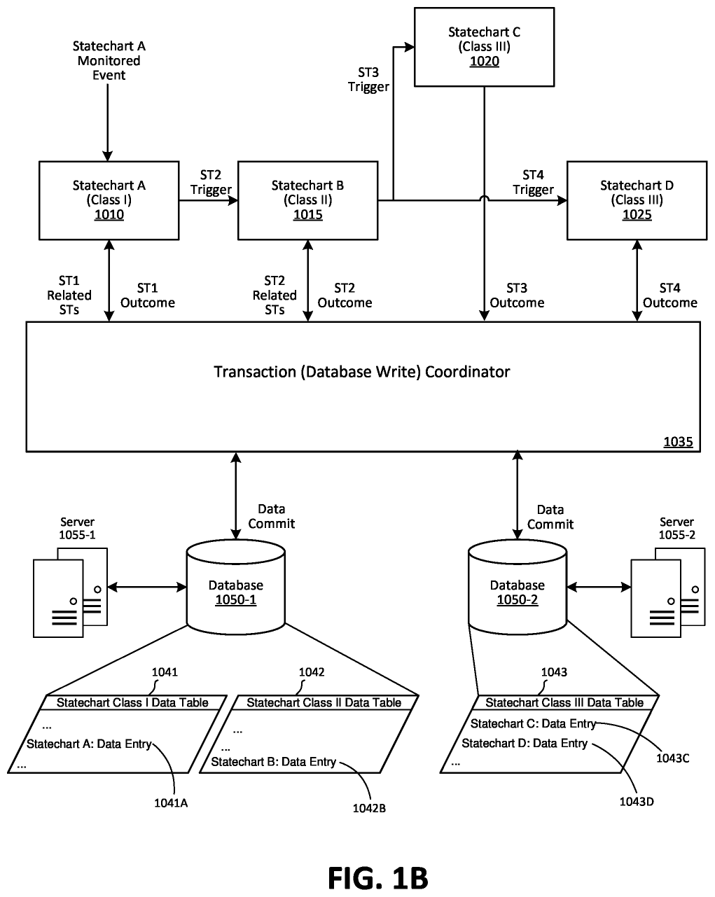

FIG. 1A is a block diagram illustrating an example network system configured to implement statecharts in fulfilling a network service, in accordance with examples described herein. In some implementations, the network system 100 can comprise a plurality of physical computer systems or server systems that may reside at disparate physical locations. The network system 100 can implement and manage the network service which connects requesting users 171 with transport service providers 181 that are available to service the users' requests 176 for service. The network service can provide a platform that facilitates services to be requested and provided between requesting users 171 (“users” or “requesters”) and available transport service providers 181 by way of a user application 172 executing on the user devices 170 and a service provider application 182 executing on the provider devices 180. As used herein, a user device 170 and a provider device 180 can correspond to a computing device with functionality to execute a designated application (e.g., a user application, a provider application, etc.) associated with the network service managed by the network system 100. According to embodiments, the user device 170 and the provider device 180 can correspond to mobile computing devices, such as smartphones, tablet computers, VR or AR headsets, on-board computing systems of vehicles, smart watches, and the like.

The network system 100 can include a network interface 110 to communicate with user devices 170 and provider devices 180 over one or more networks 190 via the designated applications (e.g., user application 172, service provider application 182, etc.) executing on the devices. According to examples, a requesting user 171 wishing to utilize the network service can launch the user application 172 and transmit a request for service (e.g., request 176) over network 190 to the network system 100. In certain implementations, the requesting user 171 can view multiple different services (e.g., transport service, delivery service, etc.) managed by the network system 100. Within each service, there may be multiple classes or types of service that the user 171 may request. For instance, to request transportation, the user 171 may be able to select from ride-pooling, a basic or economy transport service, a luxury vehicle transport service, a multi-modal transport service, a van or large vehicle service, a professional service provider service (e.g., in which the service providers are certified), a self-driving vehicle service, a rickshaw service, and the like. The network system 100 can utilize the service provider locations to provide the user devices 170 with ETA data of proximate service providers for each respective service. For example, the user application 172 can enable the user 171 to scroll through each service type. In response to a soft selection of a particular service type, the network system 100 can provide ETA data on a user interface of the user application 172 that indicates an ETA for the service type and/or the locations of all proximate available vehicles for that service type. As the user scrolls through each service type, the user interface can update to show visual representations of vehicles for that service type on a map centered around the user 171 or a start location set by the user. The user can interact with the user interface of the user application 172 to select a particular service class, and transmit a request 176.

According to embodiments, the network system 100 can be configured to manage and implement the network service by modeling various aspects of the network service using statecharts. Instantiated statechart objects 153 can be maintained, at the persistent data storage level, in a database 150. As described herein, different types of statechart objects can be used to model various aspects of fulfilling a user's request for a transport service or a delivery service. Types or categories of statecharts objects instantiated and used by the network system 100 in managing the network service can include fulfillment order statechart objects 153A, transport job statechart objects 153B, offer statechart objects 153C, transport provider statechart objects 153D, waypoint statechart objects 153E, and requester statechart objects 153F. A fulfillment order statechart object 153A can be used to model the fulfillment cycle of the user's request 176 for service and a new fulfillment order statechart object can be instantiated by the network system 100 in response to each user request 176 received over the network 190. A transport job statechart object 153B can be used to model a point-to-point transport job for transporting a requesting user or for delivery one or more items. An offer statechart objects 153C can be used to model an offer or invitation for transport service provider to provided services to fulfill one or more user's requests 176. A transport provider statechart object 153D can model the current status of a transport service provider. A waypoint statechart object 153E can model the progress of a transport service provider's progress towards arriving at a waypoint and/or performing one or more actions at the waypoint (e.g., a location on a route of the transport service provider) upon arrival. And a requester statechart object 153F can be used to model the current status of a user 171. The network system 100 can instantiate, maintain, and use other types of statecharts that are not illustrated in FIG. 1A to manage and provision services for requesting users 171. For example, entity statechart objects can be used to model the current statuses of entities such as restaurants and stores that provide items (e.g., food items, groceries, etc.) that are requested for delivery for a delivery service. Procurement job statechart objects can model the progress of preparing and/or packaging the requested items.

Statecharts objects can be dynamically linked to one another and can be organized in a hierarchical manner. For instance, a fulfillment order statechart object 153A can be linked with a transport job statechart object 153B and the transport job statechart object 153B can, in turn, be linked with an offer statechart object 153C, a transport provider statechart object 153D, and a plurality of waypoint statechart objects 153E. Two statechart objects can be linked at time of instantiation, in response to a state transition of one of the statechart objects, or in response to an detecting a trigger or an event. Moreover, linked statechart objects can pass information relating to their current states to each other. As an example, ETA delay information embodied in a waypoint statechart object can be passed to the transport job statechart object that is linked with the waypoint statechart object. Remedial actions can be taken at the transport job level in response to this information. If remedial actions are unavailable at the transport job level, the ETA delay information can further be passed to the fulfillment order statechart object that is linked to the transport job statechart object and remedial actions can be taken at the fulfillment order level.

The network system 100 can include a trigger monitoring module 120 to monitor for triggers and/or events to cause the statechart instantiation and transition engine 130 of the network system 100 to instantiate new statechart objects, transition the states of existing statechart objects in response to detecting the triggers and/or events, and/or dynamically link statechart objects. The monitored triggers and/or events can include user requests 176 for service, other user input 175 (e.g., user input provided during interactions with the user application 172), provider input 183 provided by the service provider 181 in interacting with the transport service provider application 182 (e.g., an acceptance of an offer or invitation to fulfill the service request 176), and ETA updates 146 determined by an ETA determination component 145.

As an example, the trigger monitoring module 120 can receive the request 176 from the user device requesting a service (e.g., a request for a transport service, a request for a multi-modal transport service, or a request for a delivery service, etc.). In response, the trigger monitoring can generate a trigger signal 121 to cause the statechart instantiation and transition engine 130 to instantiate a new statechart object (e.g., fulfillment order statechart object 153A) to model the fulfillment cycle of the request 176 submitted by the user 171. The trigger monitoring module 120 can further monitor user inputs 175 received from the user device 170. As one example, the statechart instantiation and transition engine 130 can trigger the fulfillment order statechart object 153A to transition to a different state (e.g., to the cancelled state) in response to a user input 175 indicating a cancellation of the request 176. Furthermore, the trigger monitoring module 120 can monitor provider inputs 183 received from the provider device 180 to generate the trigger signal 121. For instance, in response to receiving a provider input 183 indicating an acceptance of an offer or invitation 141 to fulfill a request 176, the trigger monitoring module 120 can generate trigger signal to cause the statechart instantiation and transition engine to transition the offer statechart object associated with the invitation 141 to an accepted state and link the transport provider statechart object of the transport service provider to the transport job statechart object associated with the invitation 141.

According to embodiments, the network system 100 further includes provider matching 140 to match users with transport service providers. At a high level, available transport service providers 181 can be matched with requesting users 171 based on their respective locations. The matching can be performed based on one or more multi-variate optimizations to, for example, minimize the wait times for users, minimize the distance travelled by transport service providers to rendezvous with users, etc. In some implementations, the provider matching 140 can determine optimal user-to-provider pairings based on a group optimization of computed matching parameters. In this manner, provider matching can perform group matching to optimize one or more matching parameters across a group of requesting users and a group of transport service providers. In one implementation, the provider matching 140 can resolve a bipartite graph to select the optimal user-to-provider pairings.

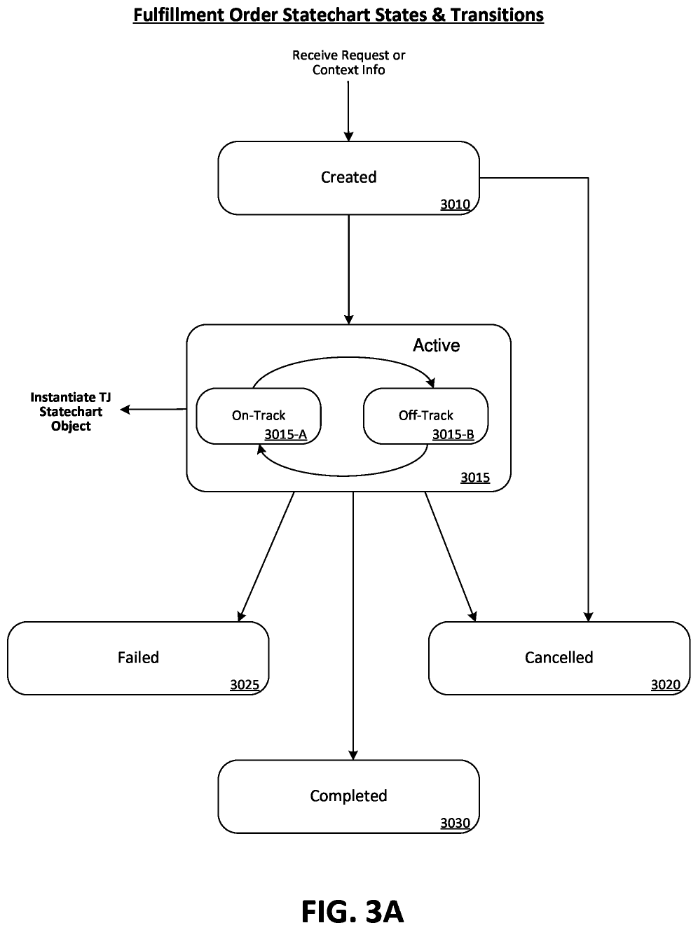

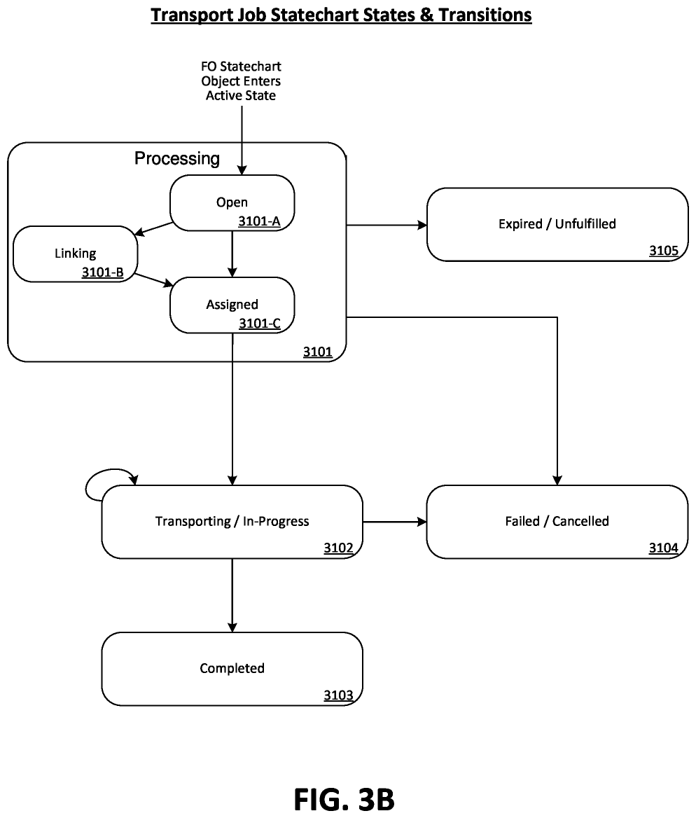

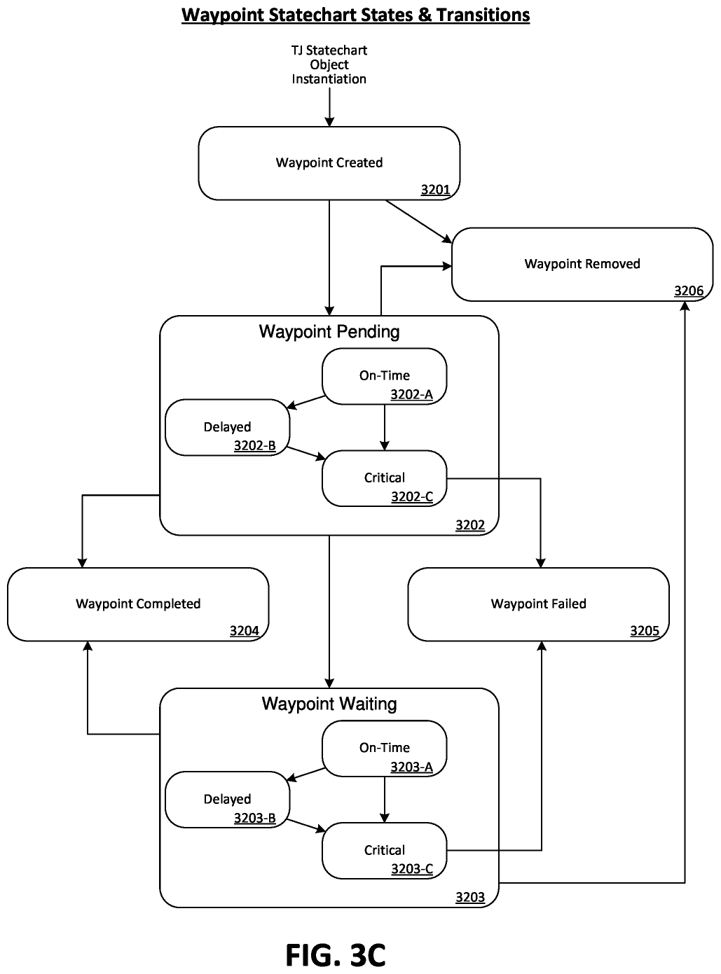

To perform user to provider matching, the statechart instantiation and transition engine 130 can relay information regarding open transport jobs 131 (e.g., transport job statechart objects having particular certain state(s), such as a Processing:Open state (see FIG. 3B)) to the provider matching 140. The provider matching 140 can match the open transport jobs 131 with available or soon-to-be available transport service providers 181. In response to a transport service provider 181 being matched to fulfill a request 176, an invitation 141 can be transmitted to the provider device 180 of the transport service provider 181. The invitation 141 can cause the provider device 180 to present a user interface for the transport service provider 181 to accept or decline the invitation 141. Furthermore, the provider matching 140 can provide an indication of a match (matched signal 142) to the statechart instantiation and transition engine 130 to cause the statechart instantiation and transition engine 130 to instantiate a new offer statechart object 153C to model the invitation 141. If a matched transport service provider 181 accepts the invitation 141 (e.g., via a received provider input 183), the statechart instantiation and transition engine 130 can transition the associated offer statechart object to an appropriate state. Furthermore, in response to the acceptance, the statechart instantiation and transition engine 130 can further link the transport provider statechart object 153D that corresponds to that transport service provider to a transport job statechart object 153B (e.g., the transport job statechart object 153B that is linked to the offer statechart object 153C of the invitation 126). If the matched transport service provider 181 declines the invitation 141, the statechart instantiation and transition engine 130 can transition the offer statechart object to a different state and cause the provider matching 140 to re-perform matching.

The network system 100 can further include transition and recovery action executor 125 to perform various functions in response to state transitions of statechart objects (e.g., by retrieving one or more recovery action instructions 154 from database 150). According to embodiments, the network system 100 can further include a transaction coordinator 135 to write transaction data to the database 150 once a set of statechart transitions are successfully completed.

FIG. 1B is a block diagram illustrating the storage of data relating to statechart objects, in accordance with examples described herein. Referring back to FIG. 1A, the elements illustrated in FIG. 1B can be implemented by the network system 100 of FIG. 1. For instance, transaction coordinator 1035 of FIG. 1B can correspond to the transaction coordinator 1035 of FIG. 1A. Furthermore, databases 1040 and 1050 of FIG. 1B can collectively implement the database 150 of FIG. 1A. The databases 1050-1 and 1050-2 can be physically separate and maintained by separate servers 1055-1 and 1055-2, respectively. To process and fulfill requests for service received from user devices over a network, the network system can instantiate and implement a plurality of statechart objects. The plurality of statechart objects can be of various classes or types, each used for modelling a corresponding aspect of fulfilling the user's requests. As discussed herein, fulfillment order statechart objects, transport job statechart objects, waypoint statechart objects, and other classes of statechart objects can be instantiated and maintained by the network system.

The network system can monitor one or more events (e.g., timer expiry, location data of user device and/or provider device, ETA determination, user or provider input, user request, context data, sensor data, etc.) to trigger a first state transition of a first statechart. In response to triggering the first state transition, a statechart transition engine (e.g., statechart instantiation and transition engine 130 of FIG. 1A) can retrieve a set of state transitions that are to be triggered in response to the first statechart transition. This can be performed based on the statechart class or type of the first statechart, the state transition of the first state transition (e.g., the beginning and ending states), and the statechart class or type of the linked statechart. The statechart transition engine can, for example, look up a predefined set of state transition rules that can dictate what related statechart transitions are to be triggered by the first state transition. This can be performed for each state transition such that the network system can dynamically determine a set of related state transitions to be triggered in response to the detected event. In addition, information pertaining to the set of related state transitions and the outcomes of each of the state transitions of the set of related state transitions can be passed to the transaction coordinator 1035 (or database write coordinator). The transaction coordinator 1035 can determine whether to write to the database(s) based on whether each of the set of related transactions is successfully completed. For instance, in response to determining that all of the state transitions of the set of related state transitions are successfully completed, the transaction coordinator 1035 can commit data relating to the state transitions to the database(s) (e.g., database 1050-1 and database 1050-2). In contrast, in response to determining that one state transition of the set of related state transitions failed, the transaction coordinator 1035 does not write any data relating to the set of related state transitions to the database and can instead cause set of related transitions to be rolled back to avoid inconsistent data being recorded the data tables. By ensuring that all related statechart transitions are successfully completed before committing data writes to the databases 1050-1 and 1050-2, the transaction coordinator 1035 can improve the integrity of the data stored in the databases 1050-1 and 1050-2. The chances of conflicting data being stored on the databases 1050-1 and 1050-2 can be significantly reduced in comparison to existing systems and solutions.

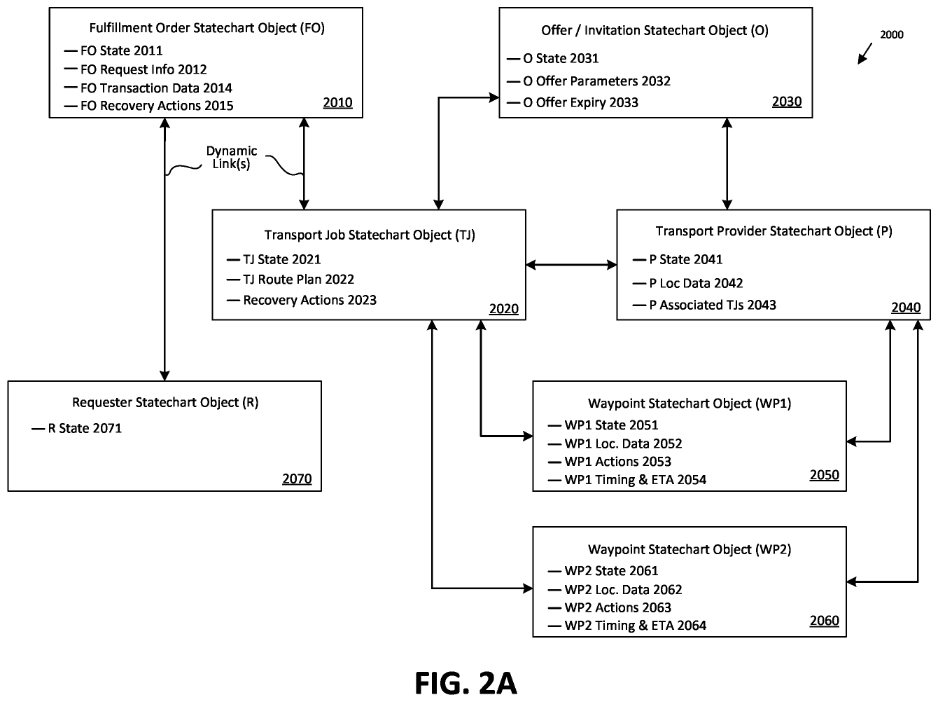

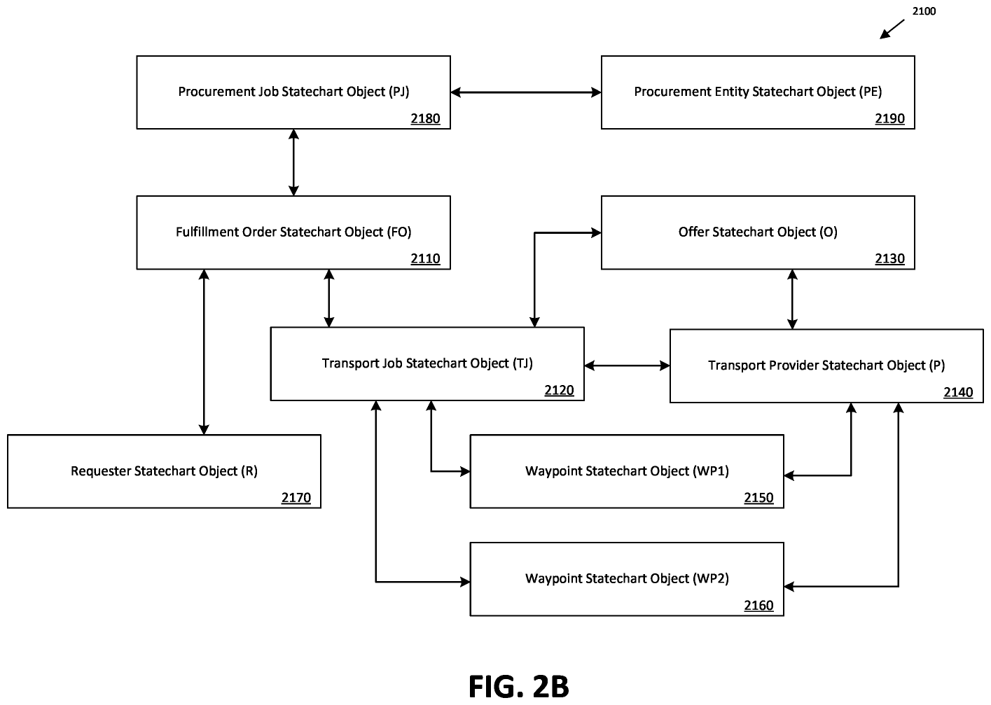

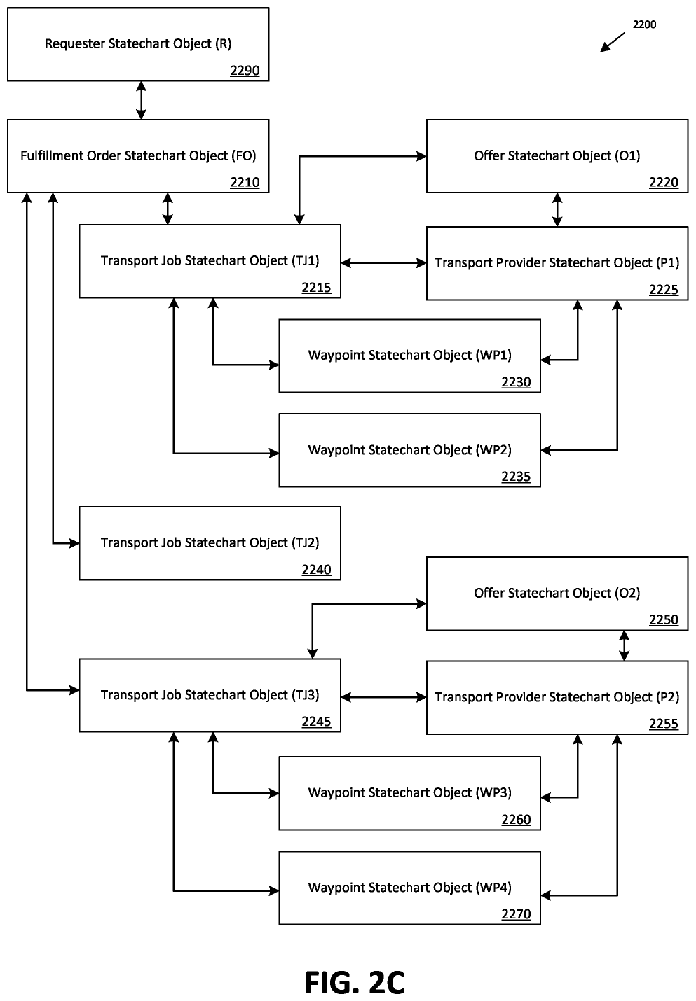

In the figure illustrated in FIG. 1B, four statechart objects of three classes or types of statecharts are illustrated: statechart A 1010 of Class I, statechart B 1015 of Class II, and statechart C 1020 and statechart D of Class III. As one example, statechart A 1010 can be an instantiated fulfillment order statechart object, statechart B 1015 can be an instantiated transport job statechart object, and statechart C 1020 and statechart D 1025 can be waypoint statechart objects. The statechart objects illustrated in FIG. 1B can be dynamically linked such that a state transition of one statechart object can trigger one or more linked statechart objects to transition states. For instance, as illustrated in FIG. 2A, a fulfillment order statechart object (e.g., statechart A 1010 of FIG. 1B) can be dynamically linked to a transport job statechart object (e.g., statechart B 1015 of FIG. 1B), and the transport job statechart object can in turn be dynamically linked to two waypoint statechart objects (e.g., statechart C 1020 and statechart D 1025 of FIG. 1B).

The network system can monitor one or more events (Statechart A Monitored Event) to trigger a state transition of statechart A 1010 (statechart transition 1 or ST1). The statechart transition engine determine one or more statechart transitions that are to be performed in response to ST1 (ST1 related STs). To do so, the statechart transition engine can perform a lookup of the dynamic links of statechart A 1010 and determine which of the statecharts linked to statechart A 1010 should be triggered to transition states (as well as to which states those statecharts should be transitioned). As an example, whether to transition statechart B 1015 and/or to which state statechart B 1015 should be transitioned in response to ST1 can be determined based on one or more of: (i) statechart class or type of statechart A 1010, (ii) statechart class or type of statechart B 1015, (iii) statechart transition of ST1 (e.g., beginning state, ending state, etc.), (vi) current state of statechart B 1015, or (v) current state of one or more statecharts linked to statechart A 1010 and/or statechart B 1015. The network system can maintain, for example, a set of statechart transition rules for this purpose (e.g., statechart transition rules 152 of FIG. 1A).

The statechart transition engine can pass information pertaining to statechart transitions that are triggered by or related to ST1 (ST1 Related STs) to the transaction coordinator 1035. In this manner, the transaction coordinator 1035 can monitor whether statechart transitions that are triggered by ST1 are successfully completed. The statechart transition engine can also pass information relating to whether ST1 was successfully completed (ST1 Outcome) to the transaction coordinator 1035. In the example illustrated in FIG. 1B, ST1 can trigger statechart transition 2 (ST2) of statechart B 1015. ST2 can trigger two statechart transitions, statechart transition 3 (ST3) of statechart C 1020 and statechart transition 4 (ST4) of statechart D. The statechart transition engine can also pass information pertaining to the statechart transitions that are triggered by ST2 (ST2 Related STs) to the transaction coordinator 1035. In addition, the statechart transition engine can transmit to the transaction coordinator 1035 information relating to whether ST2 was successfully completed (ST2 Outcome). Furthermore, the statechart transition engine can transit to the transaction coordinator 1035 whether ST3 was successfully completed (ST3 Outcome) and whether ST4 was successfully completed (ST4 Outcome).

As illustrated in FIG. 1B, through the use of dynamically linked statechart objects, Statechart A Monitored Event triggered statechart transitions ST1, ST2, ST3, and ST4. Accordingly, ST1 through ST4 can be considered a set of related statechart transitions that corresponds to Statechart A Monitored Event. The transaction coordinator 1035 can monitor the outcomes of the set of related statechart transitions (ST1 Outcome to ST4 Outcome) to determine whether each of the set of related statechart transitions was successfully completed. If ST1 through ST4 were each successfully completed, the transaction coordinator can write the resulting states of the statechart objects A through C to the databases 1050-1 and 1050-2.

According to embodiments, a plurality of data tables can be used to as persistent storage of statechart information. Each data table can be used to store instantiated statechart objects of a corresponding class or type. As illustrated in FIG. 1B, data table 1041 can store data corresponding to the instantiated statechart objects of Statechart Class I, data table 1042 can store data corresponding to the instantiated statechart objects of Statechart Class II, and data table 1043 can store data corresponding to the instantiated statechart objects of Statechart Class III. As an example, data table 1041 can store the instantiated fulfillment order statechart objects (Statechart Class or Type I) maintained by the network system across all service regions. As an alternative, data table 1041 can store the instantiated fulfillment order statechart objects corresponding to a particular service region (e.g., a region in which requests for services are received and fulfilled, such as the San Francisco Bay Area). Similarly, data table 1042 can store the transport job statechart objects (Statechart Class or Type II) maintained by the network system and data table 1043 can store the waypoint statechart objects (Statechart Class or Type III) maintained by the network system.

In various implementations, each statechart object can be represented by one row in the data table. For instance, Statechart A 1010 can be represented by a row of data (e.g., data entry 1041A) within data table 1041. Similarly, Statechart B 1015 can be represented by a row of data (e.g., data entry 1042B) within data table 1042, Statechart C 1020 can be represented by a first row of data (e.g., data entry 1043C) within data table 1043, and Statechart D 1025 can be represented by a second row of data (e.g., data entry 1043D) within data table 1043. Each data entry can include, for example, a unique identifier of the statechart object, the current state of the statechart object, identifiers of other statecharts that are dynamically linked to the statechart object, a timestamp (e.g., corresponding to when the last set of data was written to the data entry), and the like.

According to embodiments, transaction coordinator 1035 can monitor whether each of the set of related statechart transitions triggered by the Statechart A Monitored Event (ST1, ST2, ST3, and ST4) are successfully completed. In response to determining that each of the set of related statechart transitions are successfully completed, the transaction coordinator 1035 can write data to the databases 1050-1 and 1050-2 to update the entries within each data table that correspond to the statechart objects. For instance, data is written to entry 1041A within data table 1041 to reflect the updated state of statechart A 1010 and data is written to entry 1042B to reflect ST2 of statechart B 1015. Similarly, data entries 1043C and 1043D are updated.

In the manner described herein, the likelihood of inconsistent statechart information data (e.g., data indicating only a subset of the related statechart transitions being completed) being maintained across the data tables 1041 through 1043 is significantly reduced. And when state information of the statecharts A through D are retrieved by querying the databases 1050-1 and 1050-2, data that is internally consistent can be retrieved. Statecharts objects related to past service requests can also be maintained in the same data tables for logging purposes. For instance, statechart B can correspond to a transport job statechart object. Once the transport job is completed, statechart B can be persistently maintained within data table 1042 (e.g., while having a Transport Job Completed state).

Statechart Objects

FIGS. 2A through 2C illustrate example statechart objects associated with a user's request for a service, in accordance with examples described herein. The exemplary statechart objects illustrated in FIGS. 2A through 2C can be used to model various aspects of the processes performed by a network system (e.g., network system 100 of FIG. 1A) to fulfill the services (e.g., a transport service, a multi-modal transport service, a delivery service, etc.) requested by the user. For instance, the entities involved in the fulfillment of the requested services (e.g., a transport service provider for a transport request, a restaurant or store and a courier for a delivery service, etc.) and the information associated with these entities can be modelled using statecharts. Similarly, fulfillment cycle of the user's request can be modelled as fulfillment order statechart objects. The statechart objects illustrated in FIG. 2A can be dynamically linked and unlinked as needed to model and/or represent information needed to fulfill the user's request.

In FIG. 2A, block diagram 2000 illustrates a set of statechart objects for modelling various aspects of fulfilling a user's request for a transport service. In particular, to fulfill the request for the transport service, the network system can instantiate and/or manage fulfillment order statechart object 2010, transport job statechart object 2020, offer or invitation statechart object 2030, provider statechart object 2040, a first waypoint (WP1) statechart object 2050, a second waypoint (WP2) statechart object 2060, and a requester statechart object 2070.

The statechart objects shown in FIG. 2A can be associated with one another via dynamic links. The block diagram illustrates the relationships and dynamic links between the statechart objects. For instance, the fulfillment order statechart object 2010 can be dynamically linked to the transport job statechart object 2020. The transport job statechart object 2020 in turn can be dynamically linked to each of the offer statechart object 2030, the transport provider statechart object 2040, the first waypoint (WP1) statechart object 2050, and the second waypoint (WP2) statechart object 2060. The dynamic links between the statechart objects can be created (or removed) at the time of instantiation of a statechart object, in response to a trigger event, or in response to a statechart state transition, as described herein. By dynamically linking one statechart object with another, state transition and other information can be passed between the linked statechart objects. For instance, a first statechart object can be caused to transition to a different state in response to a state transition of a second statechart object that is dynamically linked to the first statechart object. Furthermore, information pertaining to the dynamic links of each statechart object can be maintained in the manner described in, for example, FIG. 1B. As described in FIG. 1B, data pertaining to an instantiated dynamic statechart object can be maintained as a data entry (e.g., a row of data) within a data table for storing instances of statechart objects of the same statechart type. And the dynamic links of a statechart object can be stored along with other statechart information in the data entry.

Fulfillment order statechart object 2010 can be instantiated by the network system 100 in response to receiving a request for service received from a user device over a network. The fulfillment order statechart object 2010 can be used to model the fulfillment cycle of the user's request and each request being serviced by the network system can be modeled using a unique fulfillment order statechart object. Like any statechart object, the fulfillment order statechart object 2010 can be transitioned to one of a plurality of states (e.g., fulfillment order states) depending on the current state of the fulfillment cycle. Additional details regarding the states and transitions of states of fulfillment order statechart object 2010 is illustrated in and described with respect to FIG. 3A. The fulfillment order statechart object 2010 can include information such as state information (FO state 2011) of the fulfillment order statechart object 2010, information pertaining to the user's request associated with the fulfillment order (FO request information 2012), transaction data needed to process the financial transaction(s) that will be performed as a result of the fulfillment of the user's request (FO transaction data 2014), and a set of instructions for performing recovery actions (FO recovery actions 2015) in the event of a failure of a state transition or a transport job associated with the fulfillment order statechart object 2010 (e.g., transport job statechart object 2020) reaching a critical state. State information of a statechart object, such as FO state 2011, can include information regarding current state(s) (e.g., current hierarchical states), permissible state transitions, impermissible state transitions (transition guards), etc. Examples of states and state transitions of the fulfillment order statechart object 2010 are illustrated in and described with respect to FIG. 3A. The fulfillment order statechart object 2010 can be linked with a requester statechart object 2070 that models the state and status of the requesting user (e.g., using requester state 2071).

According to embodiments, the FO request information 2012 can include detailed information regarding the users request, including the type of service requested. The creation and linking of subordinate or dependent statechart objects can be performed based on the FO request information 2012. For instance, in the block diagram 2000 illustrated in FIG. 2A, the request received from the user device can be a request for point-to-point transport service (e.g., a rideshare service). As a result, a single transport job statechart object 2020 can be instantiated and linked to fulfillment order statechart object 2010 in response to the fulfillment order state chart object 2010 being instantiated. In other cases, the received request can be for a delivery service or for multi modal transport service. In such cases, the fulfillment order statechart object can be dynamically linked to other and/or additional statechart object.

The fulfillment order statechart object 2010 can be linked to the transport job statechart object 2020, which can be instantiated by the network system in response to the fulfillment order statechart object 2010 being instantiated. The transport job statechart object 2020 can be used to model and represent a point-to-point transport job associated with the request that is associated with the fulfillment order statechart object 2010 (e.g., to transport the requesting user via the point-to-point transport service requested). The transport job statechart object 2020 can include information such as the state information (TJ state 2021) of the transport job statechart object 2020, the route plan of the transport job (TJ route plan 2022), and a set of instructions to perform route delay recovery actions (TJ route delay recovery actions 2023). Examples of states and state transitions of the transfer job statechart object 2020 are illustrated in and described with respect to FIG. 3B.

The transport job statechart object 2020 can in turn be linked to the offer statechart object 2030, which can be dependent or subordinate to the transport job statechart object 2020. The offer statechart object 2030 can be used to model an offer or invitation to a transport service provider that has been identified to provide the requested service for the requesting user. The offer statechart object 2030 can include information such as state information (0 state 2031) of the offer statechart object 2030, a set of parameters related to the offer (0 offer parameters 2032), and expiration time associated with the offer (0 offer expiry 2033). As an example, the network system can perform a matching process to identify a transport service provider from a plurality of available transport service providers to fulfill the request received from the requesting user device. The transport service provider can be identified based at least in part on the provider's current location (or ETA) relative to the requesting user's location. In response to identifying the transport service provider, the offer or invitation statechart object 2030 can be instantiated. As illustrated, the offer statechart object 2030 can also be linked to the transport provider statechart object 2040. The parameters determined during the matching process (e.g., value of payment that can be expected by the matched transport service provider for fulfilling the service request) can be stored as offer parameters 2032. Moreover, in response to identifying the transport service provider and/or in response to instantiating the offer or invitation statechart object 2030, a set of data corresponding to an invitation to provide service to fulfill the request can be transmitted to a provider device of the identified service provider. The set of data corresponding to the invitation can cause the provider device to display information relating to the invitation to provide services to fulfill the request (e.g., the expected value, requested service type, pick-up location, destination location, etc.). The provider device can also present one or more user interface features on the provider application executing on the provider device to allow the identified service provider to accept or decline the invitation. The offer may also have an expiration such that if the identified service provider does not respond or accept the invitation prior to the expiration, the offer or invitation can be invalidated or cancelled. The information relating to the offer expiration can be stored as O offer expiry 2033.

Once the identified service provider accepts the invitation, the transport provider statechart object 2040 can be dynamically associated with the transport job statechart object 2020. For instance, the transport provider statechart object 2040 can be dynamically linked to the transport job statechart object 2020 in response to the network system receiving an acceptance message from the provider device of the service provider. The provider statechart object 2040 can be used by the network system to model the status, state, and information relating to a transport service provider in providing transport services and/or delivery/courier services. Each transport provider statechart object maintained by the network system can be associated with a corresponding one of a plurality of transport service providers. As the transport service providers go online and offline (e.g., via the provider application executing on their respective provider devices), accept invitations, arrive at waypoints, and complete tasks, the network system can transition the states of the provider statechart objects to model the transport service provider actions and their statuses. The transport provider statechart object 2040 can include state information (P state 2041) of the provider statechart object 2040, current location or location coordinates (P location data 2042) of the transport service provider, and identification of transport jobs statechart objects (P associated TJs 2043) associated with the provider statechart object. As described herein, a provider statechart object can be simultaneously linked to or associated with a plurality of transport job statechart objects, each of which is associated with a different fulfillment order statechart object. In this manner, a transport service provider can be simultaneously associated with a plurality of transport jobs (e.g., when the transport service provider provides a rideshare transport service simultaneously for multiple users, when the transport service provider is provisionally associated with a second requesting user while being en-route to drop off a first requesting user, etc.).

According to embodiments, the transport job statechart object 2020 is associated with or dynamically linked with a plurality of waypoint statechart objects (e.g., WP1 statechart object 2050 and WP2 statechart object 2060). A waypoint can be a location on the route plans (e.g., TJ route plan 2022) of the transport job statechart objects. And according to embodiments, a waypoint statechart object can be used to model or track a transport service provider's progress in arriving at that location and/or in completing one or more tasks the transport service provider is to complete (e.g., pick-up or drop off requesting user, pick up or drop off item(s) to be delivered, etc.). Each of the waypoint statechart objects 2050 and 2060 can include state information (WP1 state 2051 and WP2 state 2061), location information (WP1 location data 2052 and WP2 location data 2062) such as the location coordinates of the corresponding waypoints, actions that the transport service provider is to perform at the waypoints (WP1 actions 2053 and WP2 actions 2054), and timing and estimated time of arrival information (WP1 timing & ETA 2054 and WP2 timing & ETA 2064). As illustrated in FIG. 2A, WP1 waypoint statechart object 2050 can model the transport service provider's progress towards the pick-up location and WP2 waypoint statechart object 2060 can model the transport service provider's progress towards the drop-off location. WP1 actions 2053 can indicate that the transport service provider is to pick up the requesting user at the location indicated by WP1 location data 2052. Similarly, WP2 actions 2063 can indicate that the transport service provider is to drop off the requesting user at the location indicated by WP2 location data 2062. Examples of states and state transitions of the waypoint statechart object 2050 or 2060 are illustrated in and described with respect to FIG. 3C.

In various implementations, the two statechart objects 2050 and 2060 can also be linked to the transport provider statechart object 2040. For instance, the transport provider statechart object 2040 can be linked to the two waypoint statechart objects 2050 and 2060 in response to the transport provider accepting the offer. The service provider application executing on the transport provider device can access the waypoint information in displaying a navigation route for the transport provider. By linking the transport provider statechart object 2040 with the waypoint statechart objects, an update of either of the waypoints (e.g., via a requester input) processed at the transport job or fulfillment order level can be quickly propagated to the transport provider.

In FIG. 2B, block diagram 2100 illustrates a set of statechart objects for modelling various aspects of fulfilling a user's request for a delivery service. As illustrated in FIG. 2B, to fulfill a user's request for a delivery service, the network system can instantiate and/or manage fulfillment order statechart object 2110, transport job statechart object 2120, offer statechart object 2130, provider statechart object 2140, a first waypoint (WP1) statechart object 2150, and a second waypoint (WP2) statechart object 2160. The statechart objects 2110 through 2160 can be similar to those described with respect to FIG. 2A (e.g., statechart objects 2010 through 2060). The transport job statechart object 2120 can be used for modeling transporting or more items for delivery rather than the transportation for the request user. Accordingly, WP1 2150 can model, among other aspects, the progress of the transport provider in picking up one or more delivery items rather than the progress of the transport provider in picking up the requesting user (as does WP1 2050 of FIG. 2A). Similarly, WP2 2160 can model the progress of the service provider in delivering one or more items for delivery rather than the progress of the transport provider in dropping off the requesting user (as does WP2 2060 of FIG. 2A). In addition to these statechart objects, a procurement job statechart object 2180 and a procurement entity statechart object 2190 can also be instantiated. The procurement job statechart object 2180 in particular can be linked to the fulfillment order statechart object 2110 and the procurement entity statechart object 2190 can be linked to the procurement job statechart object 2180. The procurement job statechart object 2180 can be used to model the progress of the preparation of one or more items (e.g., one or more food items) requested by the user and the procurement entity statechart object 2190 can be used to model the entity (e.g., restaurant, bar, store, merchant, etc.) that is to provide the one or more requested items.

In FIG. 2C, block diagram 2200 illustrates a set of statechart objects for modelling various aspects of fulfilling a user's request for a multi-modal transport service. A multi-modal transport service can involve multiple segments, at least some of the multiple segments can be provided using different transport service types. For instance, a multi-modal transport service can include a first segment that is provided by a first transport service provider, a second segment that is taken on a public transit (e.g., bus or train), and a third segment that is provided by a second transport service provider. The first and third segments can be provided as the same transport service type (e.g., a rideshare transport type) or provided using different transport service types. As another example, the first segment can be provided as a rideshare transport, the second segment can be taken on a public transit, and the third segment can be fulfilled as a micro-mobility service (e.g., a bicycle or scooter rental service).

As illustrated in FIG. 2C, to fulfill a user's request for a multi-modal transport service, the network system can instantiate a fulfillment order (FO) statechart object 2210. The fulfillment order statechart object 2210 can be dynamically linked to a plurality of transport job statechart objects (e.g., transport job (TJ1) statechart object 2215, transport statechart (TJ2) object 2240, and transport statechart (TJ3) object 2245). And each of the transport statechart objects associated with or linked to the fulfillment order statechart object 2210 can model a corresponding one of the multiple segments of the multi-modal transport service being provided for the requesting user. For instance, TJ1 statechart object 2215 can model the first segment of the multi-modal transport service (e.g., a first transport service provider transporting the requesting user to a public transit origination location), TJ2 statechart object 2240 can model the second segment (e.g., the public or mass transit taken by the requesting user from the public transit origination location to a public transit destination location), and TJ3 statechart object 2245 can model the third segment (e.g., a second transport service provider transporting the requesting user from the public transit destination location to a drop off location). In certain implementations, one or more waypoint statechart objects (not illustrated in FIG. 2C) can be used in modeling the public transit segment of the multi-modal transport service. For instance, a waypoint statechart object can be used to model the user's progress towards a transit on/off-boarding location (e.g., a train station).

Statechart State Transitions

FIGS. 3A to 3C illustrate exemplary states and state transitions of statechart objects, in accordance with examples described herein. FIG. 3A illustrates exemplary states and state transitions of a fulfillment order statechart object. As illustrated in FIG. 3A, a fulfillment order statechart object can be in one of a plurality of states, including a Create state 3010, an Active state 3015, a Cancelled state 3020, a Completed state 3030, and a Failed state 3025. The Active state 3015 can be a compound state having two sub-states including an On-Track sub-state 3015-A and an Off-Track state 3015-B. Because other statechart object types can have state names that are similar, for clarity, the Created state 3010 can be referred to herein as the Fulfillment Order Created state, the Completed State 3030 can be referred to herein as the Fulfillment Order Completed state, and the like.

The fulfillment statechart object can be instantiated in the Created state in response to the network system receiving a request for service from a requesting user device. From the Created state 3010, the fulfillment order statechart object can transition to the Active state 3015. In many cases, the fulfillment statechart object can automatically transition to the Active state 3015 when the network system begins the process to fulfill the request associated with the fulfillment order statechart object. In some other cases, the Active state can be transitioned into depending on the parameters and details of the request. For instance, if the request for service is a scheduled request for service at a future time (e.g., a transport request for a future pick-up time, a scheduled delivery request, etc.), the network system can determine a time at which the fulfillment statechart object should transition into the active state to begin the fulfillment process of the scheduled request. The fulfillment statechart object can remain in the Created state 3010 and transition into the Active state 3015 at the determined time (e.g., upon expiry of a timer associated with the state transition).

In certain implementations, the fulfillment order statechart object can also be instantiated in the Created state 3010 in response to receiving context information from the user device indicating that user is likely to submit a request for service in the near future. The context information can include data indicating user interactions with the user service application, location and other sensor data collected by the user device, and the like. Thus, the fulfillment order statechart object can be instantiated prior to the user submitting a request for service via the user service application. In such cases, the fulfillment order statechart object can transition to the Active state 3015 in response to receiving the request from the user device.

According to embodiments, the Active state 3015 of the fulfillment order statechart object can be used to model the active fulfillment of a request from the user. The Active state 3015 can be a compound state that includes two sub-states, including an On-Track state 3015-A and an Off-Track state 3015-B. The statechart object can be in the On-Track state 3015-A when the fulfillment cycle is on-track to be completed and in the Off-Track state 3015-B when one or more issues are detected (e.g., detected delays of the transport service provider in arriving at one or more waypoints, etc.) during the fulfillment process that needs to be resolved at the fulfillment order level (e.g., creation of a new transport job etc.). As illustrated in FIG. 3A, in certain implementations, the fulfillment order statechart object transitioning to the Active state 3015 can cause the instantiation of a linked transport job statechart object. As an alternative, the linked transport job statechart object can be instantiated when the fulfillment order statechart is first instantiated (e.g., in the Created state 3010). For requests for service types other than a point-to-point transport service, such as requests for a delivery service, or requests for a multi-modal transport service, and the like, the fulfillment order statechart object transitioning to the Active state 3015 (or being instantiated) can cause other statechart objects to be instantiated. For instance, for a request for a delivery service, the fulfillment order statechart object transitioning to the Active state 3015 can cause a procurement job statechart object, in addition to the transport job statechart, to be instantiated and linked to the fulfillment order statechart object. For a request for a multi-modal transport service, multiple transport jobs can be instantiated and linked to the fulfillment order statechart object.

The fulfillment order statechart object can transition to a Cancelled state 3020 from either the Created state 3010 or the Active state 3015 in response to a user input to cancel the submitted request. The state transition from the Active state 3015 to the Cancelled state 3020 can cause one or more other statechart objects to be transitioned to their respective cancelled states. For instance, a transport job statechart object and/or a procurement job statechart object can be transitioned to their respective cancelled states in response to the fulfillment order statechart object transitioning from the Active state 3015 to the Cancelled state 3020.

The fulfillment order statechart object can transition to a Completed state 3030 upon the completion of the fulfillment of requested services. The fulfillment order statechart object can transition to the Completed State 3030 from the Active state 3015. The fulfillment order statechart object can transition to the Completed state 3030 in response to all of the transport job statechart objects and procurement job statechart objects linked to the fulfillment order statechart object transitioning to their respective completion states. Furthermore, the fulfillment order statechart object can transition to the Failed state 3025 from the Active state 3015 in response to an unrecoverable error being encountered during the fulfillment cycle of the user's request.

FIG. 3B illustrates exemplary states and state transitions of a transport job statechart object. A transport job statechart object can be in one of a plurality of states, including (i) Processing state 3101, (ii) Transporting or In-Progress state 3102, (iii) Completed state 3103, (iv) Failed or Cancelled state 3104, and (v) an Expire or Unfulfilled state 3105. The transport job statechart object can be instantiated in response to a fulfillment order statechart object being transitioned to the Fulfillment Order Active state. Upon being instantiated, the transport job statechart object can be in the Processing state 3101. The Processing state 3101 can be used to model the transport job before the transport service provider picks up the requesting user and can be a composite state having a plurality of substates including: (i) an Open sub-state 3101-A for representing the transport job not yet been assigned to a particular transport service provider, (ii) a Linking sub-state 3101-B for representing a transport service provider in the process of being associated with or assigned to the transport job, and (iii) an Assigned sub-state 3101-C. In particular, the Assigned sub-state 3101-C can be entered into in response to an identified transport service provider accepting an offer or invitation to fulfill the request of the requesting user.

From the Assigned sub-state 3101-C of the Processing state 3101, the transport job statechart object can transition to the Transporting or In-Progress state 3102. This state can represent portion of the transport job in which the transport service provider is actively providing transport service for the requesting user. In particular, the transport job statechart object can enter into the In-Progress state 3102 from the Assigned sub-state 3101-C in response to a waypoint statechart object that corresponds to the start location transitioning to the Waypoint Complete state. From the In-Progress state 3102, the transport job statechart object can transition to the Complete state 3103 or the Failed/Cancelled state 3104.

FIG. 3C illustrates exemplary states and state transitions of a waypoint statechart object. A waypoint job statechart object can be in one of a plurality of states, including (i) Waypoint Created state 3201, (ii) Waypoint Pending state 3202, (iii) Waypoint Waiting state 3203, (iv) Waypoint Completed state 3104, (v) Waypoint Failed state 3105, and (vi) Waypoint Removed state 3206. The Waypoint Pending state 3202 can model the progress of a transport provider in traveling to the waypoint while the Waypoint Waiting state 3203 can model the progress of the service provider in completing one or more tasks (e.g., drop off the requesting user, picking up the requesting user, picking up one or more delivery items, dropping off one or more delivery items, etc.). The Waypoint Pending state 3202 can be a compound state having a plurality of sub-states used for more detailed monitoring of the progress of the service provider in traveling to the waypoint. For instance, an On-Time substate 3202-A of the Waypoint Pending state 3202 can signify that the service provider is currently on-track to arrive at the waypoint within a threshold of the estimated time of arrival computed for the service provider. The Delayed sub-state 3202-B of the Waypoint Pending state 3202 can represent the service provider being delayed and the Critical 3202-C sub-state can signify that the service provider is critically delayed. In response to transitioning to the Critical 3202-C sub-state, the network system can trigger the performance of one or more recovery actions to prevent the failure of the transport job. Similarly, the Waypoint Waiting state 3203 can also be a compound state having a plurality of sub-states, including: On-Time 3203-A, Delayed 3203-B, and Critical 3203-C.

Methodology

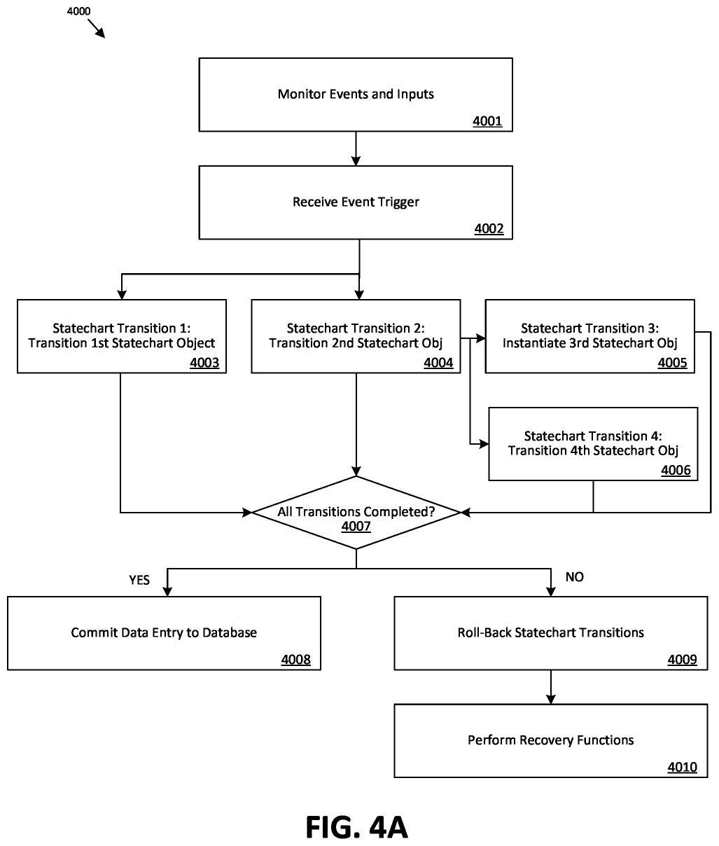

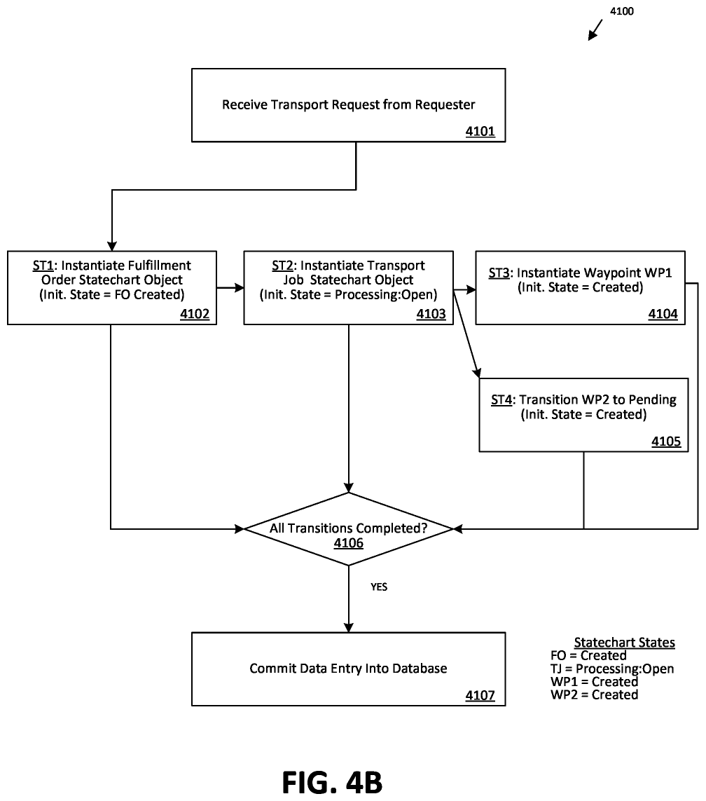

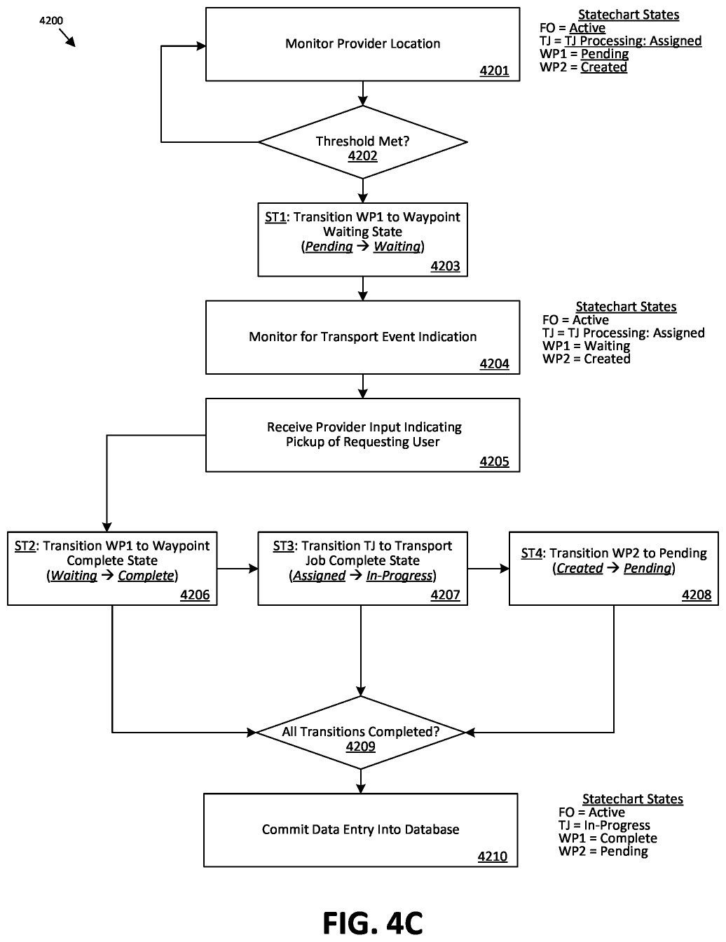

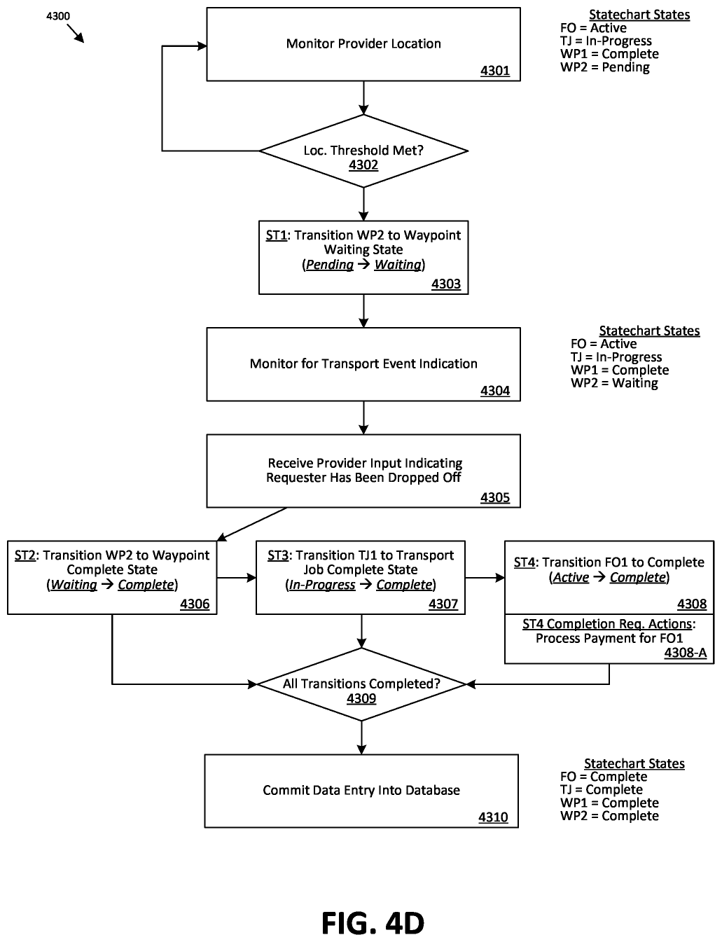

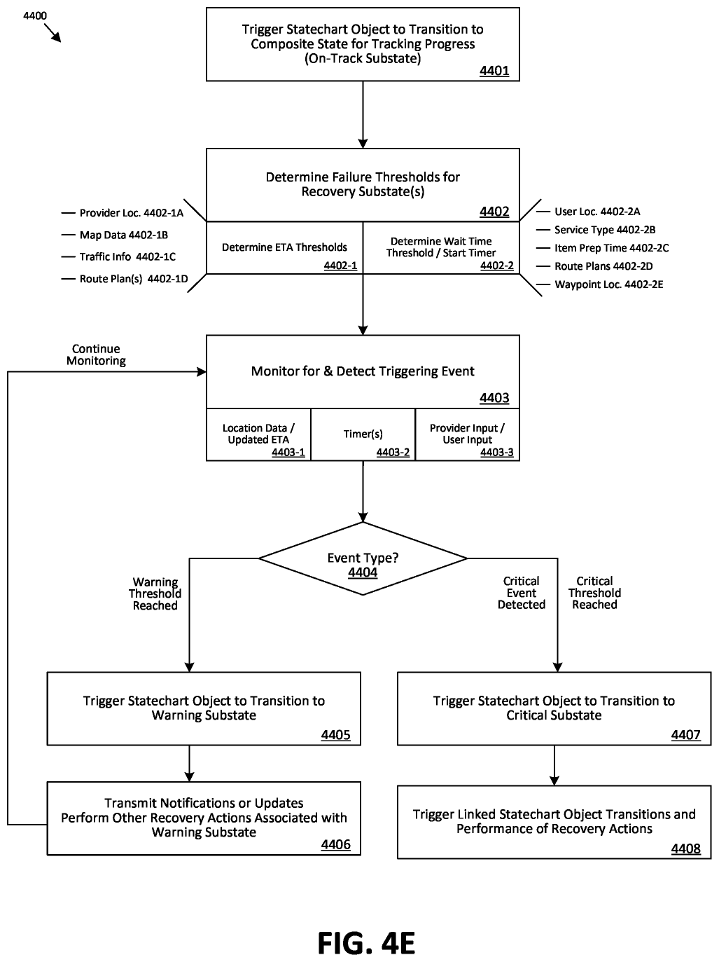

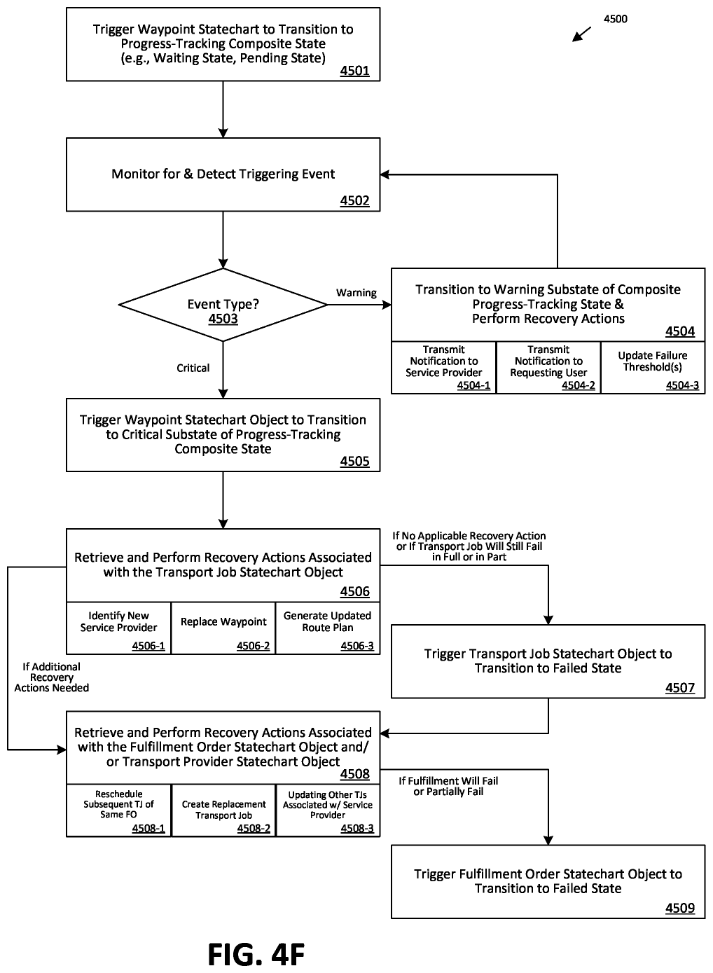

FIGS. 4A to 4D are flowchart diagrams illustrating example methods of instantiating and managing statechart objects in response to detected triggers or events, in accordance with examples described herein. The methods illustrated in FIGS. 4A to 4C can be performed by the network system 100 illustrated in and described with respect to FIGS. 1A and 1B.

FIG. 4A is a flowchart diagram illustrating an example method of monitoring for events and trigger statechart transitions. While FIG. 4A illustrates a generic example of processing a detected event, specific examples of processing specific events and triggers are illustrated in FIGS. 4B to 4D. At step 4001, the network system can monitor events and inputs. The monitored events and inputs can include, for example, requests for service received from user devices, acceptance of offers or invitations received from provider devices, other input via user or provider service applications, location data, ETA updates, context data, device sensor data, etc.

At step 4002, the network system can receive the event trigger. As part of processing the detected event, the network system can perform a number of statechart transitions (e.g., a set of related statechart transitions) in response to receiving the event trigger. As illustrated in FIG. 1A, the set of related statechart transitions can include four statechart transitions (steps 4003 through 4006) of four statechart objects. The detected event can be a statechart transition or instantiation trigger for a first statechart object which can a first statechart transition at step 4003. The detected event can also be a trigger for a second statechart object which transitions to a new state at step 4004. In other words, the detected event can be a trigger event for both the first and second statechart objects. In some implementations, the first statechart transition at step 4003 and the second statechart transition at step 4004 can be performed in parallel by the network system to reduce processing time. As illustrated in FIG. 1A, the first statechart transition at step 4003 does not trigger additional statechart transitions. On the other hands, the second statechart transition of the second statechart object at step 4004 can trigger two statechart transitions: a third statechart transition at step 4005 of a third statechart object and a fourth statechart transition at step 4006 of a fourth statechart object. The third and fourth statechart objects can be dynamically linked to the second statechart object. In response to triggering the second statechart transition of the second statechart object (step 4004), a statechart instantiation and transition engine can look up the statechart objects linked to the second statechart object and determine that the third and fourth statechart objects should be transitioned in response to step 4004. Similar to steps 4003 and 4004, the network system is configured to process steps 4005 and 4006 in parallel to reduce computation time.

A transaction coordinator can monitor each of the statechart transitions (steps 4003 through 4006). At step 4007, the transaction coordinator can determine whether all the statechart transitions that were performed in response to the detected event (e.g., steps 4003 through 4006) were successfully completed. At step 4008, if each of the statechart transitions were successfully completed, the transaction coordinator can write data to one or more databases to record the new states of the statechart objects (e.g., the resulting state the first statechart object after the first statechart transition performed at step 4003, etc.) in persistent storage. If at least one of the statechart transitions failed, the transaction coordinator can, at step 4009, cause the other statechart transitions (e.g., the statechart transitions that did not fail) to be rolled back. In this manner, the transaction coordinator can prevent inconsistent data regarding the statechart objects to be written into persistent storage and data consistency and integrity is improved. In addition, the network system can further perform one or more recovery functions at step 4010 in response to the transaction coordinator determining that at least one of the statechart transitions was not successfully completed.

FIG. 4B is a flowchart diagram illustrating an example method of instantiating statechart objects in response to a transport request received from a requesting user. At step 4101, the network system can receive a transport request from a requesting user device. The transport request can indicate a start location (e.g., where a transport service provider is to rendezvous with and pick up the requesting user) and a service location (e.g., where the transport service provider is to drop off the requesting user). In response to receiving the transport request, at Step 4102, a first state transition (ST1) can be triggered. The first state transition can be the instantiation of a fulfillment order statechart object that is used to model the fulfillment cycle of the transport request of the requesting user. The fulfillment order statechart object can be instantiated in the initial state of Fulfillment Order Created (e.g., Created state 3010 of FIG. 3A). At step 4103, in response to the instantiation of the fulfillment statechart object, a second state transition (ST2) can be triggered. The second state transition can be the instantiation of a transport job statechart object, which can be instantiated in the initial state(s) of Transport Job Processing:Open (e.g., Processing state 3101 and Open sub-state of FIG. 3B). In response to the instantiation of the transport job statechart object, a third state transition (ST3) at step 4104 and a fourth state transition (ST4) can be triggered at step 4105. The third state transition (step 4104) can correspond to the instantiation of a first waypoint statechart object (WP1) and the fourth state transition (step 4105) can correspond to the instantiation of a second waypoint statechart object (WP2). Step 4104 and step 4105 can be performed in parallel by the network system. And the first waypoint statechart object can be used to model the transport service provider's progress towards the start location and the second waypoint statechart object can be used to model the transport service provider's progress towards the service location. Each of the first and second waypoint statechart objects can be instantiated in the Waypoint Created state. At step 4106, a transaction coordinator can determine whether each of the state transitions represented by steps 4102 to 4105 have been successfully completed. If the transitions are all successfully completed, transaction data associated with the state transitions can be committed to a database for storing statechart object data (step 4107).

FIG. 4C is a flowchart diagram illustrating an example method of transitioning states of statechart objects in response to an detecting an event corresponding to a transport service provider picking up a requesting user, in accordance with examples described herein. The flowchart 4200 can illustrate an exemplary process that begins with step 4201 in which the network system monitors the location of a service provider that is assigned to fulfill a transport request of a user and is progressing towards a start location to rendezvous with the requesting user. At or prior to step 4201, a fulfillment order statechart object has been instantiated and is in the FO Active state. A transport job statechart object has also been instantiated, is linked to the fulfillment order statechart object, and is in the Transport Job Processing:Assigned state and sub-state. Two waypoint statechart objects are instantiated and linked to the transport job statechart. A first waypoint statechart object (WP1) can correspond to the start location and is in the Waypoint Pending state whereas a second waypoint statechart object (WP2) can correspond to the service location and is in the Waypoint Created state. In step 4201, the network system can continuously or periodically communicate with the provider device of the assigned transport service provider to receive location data (e.g., GPS data, GLONASS data, etc.) to determine the transport service provider's location relative to the next waypoint (e.g., WP1) on the route plan determined for the transport service provider. If it is determined at step 4202 that the transport service provider is within a predetermined distance threshold (or within an ETA threshold) from the start location, the network system can trigger a first state transition (ST1) to cause WP1 to transition from the Waypoint Pending state (e.g., the On-Track Substate of the Waypoint Pending state) to the Waypoint Waiting state (e.g., the On-Track Substate of the Waypoint Waiting state) (step 4203). While in the Waypoint Waiting state, the network system can monitor for a transport event indication from the provider device step 4204. At step 4205, the network system can receive such a transport event indication. This transport event indication can be a provider input received via a provider service application executing on the provider device indicating that the transport service provider has rendezvoused and picked up the requesting user. In response to receiving the provider input, the network system can trigger a second state transition (ST2) to transition WP1 from the Waypoint Waiting state to the Waypoint Complete state at step 4206. In response to WP1 transitioning to the Waypoint Complete state, the network system can, at step 4207, trigger a third state transition (ST3) to transition the transport job statechart object from the Transport Job Processing:Assigned state and sub-state to the Transport Job In-Progress state. At step 4208, the transition of the transport job statechart object to the In-Progress state can trigger a fourth state transition (ST4) in which the second waypoint statechart object (WP2) is transitioned from the Waypoint Created state to the Waypoint Pending state. At step 4209, the transaction coordinator determines whether each of the state transitions related to the provider input received at step 4205 (ST2 to ST4) have been successfully completed. If the state transitions of ST2 to ST4 have all been successfully completed, transaction data associated with the state transitions can be committed to a database for storing statechart object data (step 4210).

FIG. 4D is a flowchart diagram illustrating an example method of transitioning states of statechart objects in response to an detecting an event corresponding to a transport service provider dropping off a requesting user, in accordance with examples described herein. The flowchart 4300 can illustrate an exemplary process that begins with step 4301 in which the network system monitors the location of a service provider that is providing transportation for a requesting user and progressing towards a service location to drop off the requesting user. At or prior to step 4301, a fulfillment order statechart object has been instantiated and is in the FO Active state. A transport job statechart object has also been instantiated, is linked to the fulfillment order statechart object, and is in the Transport Job In Progress state. Two waypoint statechart objects are instantiated and linked to the transport job statechart. A first waypoint statechart object (WP1) can correspond to the start location and is in the Waypoint Complete state whereas a second waypoint statechart object (WP2) can correspond to the service location and is in the Waypoint Pending state. In step 4301, the network system can continuously or periodically communicate with the provider device of the assigned transport service provider to receive location data (e.g., GPS data, GLONASS data, etc.) to determine the transport service provider's location relative to the next waypoint (e.g., WP2) on the route plan determined for the transport service provider. If it is determined at step 4302 that the transport service provider is within a predetermined distance threshold (or within an ETA threshold) from the service location, the network system can trigger a first state transition (ST1) to cause WP2 to transition from the Waypoint Pending state to the Waypoint Waiting state (step 4303). While in the Waypoint Waiting state, the network system can monitor for a transport event indication from the provider device step 4304. At step 4205, the network system can receive such a transport event indication. This transport event indication can be a provider input received via a provider service application executing on the provider device indicating that the transport service provider dropped off the requesting user at the service location. In response to receiving the provider input, the network system can trigger a second state transition (ST2) to transition WP2 from the Waypoint Waiting state to the Waypoint Complete state at step 4306. In response to WP2 transitioning to the Waypoint Complete state, the network system can, at step 4207, trigger a third state transition (ST3) to transition the transport job statechart object from the Transport Job In-Progress state to the Transport Job Complete state. At step 4208, the transition of the transport job statechart object to the Transport Job Complete can trigger a fourth state transition (ST4) in which the fulfillment order statechart object is transitioned to the Fulfillment Order Complete state. The transition of the fulfillment order statechart object to the FO Complete state can further trigger a set of actions to be completed by the network system including, for example, processing one or more financial transactions associated with the user's request (step 4308-A). At step 4209, the transaction coordinator determines whether each of the state transitions related to the provider input received at step 4205 (ST2 to ST4) have been successfully completed. If the state transitions of ST2 to ST4 have all been successfully completed, transaction data associated with the state transitions can be committed to a database for storing statechart object data (step 4210).

Hierarchical Failure Recovery

FIG. 4E is a flowchart diagram illustrating an example method of detecting failures, errors, or delays and performing one or more recovery actions using hierarchical or composite states of a statechart object.

In the method 4400, a statechart object can be used to track the progress of a service provider in performing one or more tasks. For instance, the statechart object can be transitioned into one or more progress-tracking composite states (e.g., the pending state, the waiting state) each having a plurality of substates. Each progress-tracking composite state can be associated with one or more tasks the service provider is to perform. Referring back to earlier figures, the method 4400 illustrated in FIG. 4E can describe state transitions of statechart objects such as the waypoint statechart object illustrated in and described with respect to FIG. 3C. As described herein, a waypoint statechart object is associated with a geographic location (e.g., a pickup location, a drop-off location, etc.) and the waypoint statechart object can be used by the network system to maintain, record and manage the status of a service provider in performing one or more actions or tasks that relate to that geographic location. For instance, the pending composite state 3202 can be used to track or monitor the service provider in navigating to or arriving at a geographic location and the waiting composite state 3203 can be used to track or monitor the service provider in performing actions such as picking up or dropping off the requesting user or picking up and dropping off requested items for delivery. Each composite state can include substates including: (i) an on-track substate (e.g., 3202-A and 3203-A) for representing that the service provider is on schedule (e.g., within certain time or ETA thresholds) in performing the task(s) associated with the composite state, (ii) a warning substate (e.g., 3202-B and 3203-B) for representing that the service provider has exceeded a first time or ETA threshold (e.g., a warning threshold value), and (iii) a critical substate (e.g., 3202-C and 3203-C) for representing that the service provider has exceeded a second time or ETA threshold (e.g. a critical threshold value) and/or the service provider is unable to complete the task(s) associated with the composite state.

In this manner, the warning substate and the critical substate of the composite state can be used to represent failures, errors, or delays of varying severity. For instance, the network system can be configured to trigger the statechart object to transition into the warning substate of the composite state in response to determining that the service provider has encountered issues but no recovery actions need to be taken at another level within the hierarchical computational framework (e.g., at the transport job level) used to represent the various aspects of fulfilling the user's request. As an example, this can include the network system determining that the service provider has encountered delays but is still able to complete the tasks associated with the composite state without jeopardizing other aspects fulfilling the request (e.g., a second leg of a multi-leg transport request) or related request(s) (e.g., a second transport request of a second user being serviced contemporaneously by the same service provider—such as a rideshare transport). On the other hand, the network system can be configured to trigger the statechart object to transition into the critical substate of the composite state in response to determining that one or more recovery actions need to be taken at a different level within the hierarchical computational framework (e.g., at the transport job level).

At step 4401, the network system is configured to trigger the statechart object (e.g., a waypoint statechart object) to transition to a composite state for tracking progress of a service provider. At a high level, a waypoint statechart object can be transitioned into a progress-tracking composite state following a state transition of the same waypoint statechart object, following a state transition of another waypoint statechart object, or following a state transition of a transport job objected linked to the same statechart object. The statechart object can be transitioned into an on-track or on-time substate of the composite state at step 4401 as part of the transition to the composite state.

At step 4402, the network system can determine failure thresholds for substates of the composite state. The failure thresholds can include ETA thresholds and/or wait time thresholds. And the failure thresholds can be used to trigger the statechart object to transition to one or more failure substates (e.g., the warning and/or critical substates). As illustrated in FIG. 4E, the failure thresholds can be dynamically determined in response to the statechart object being transitioned into the composite state.

According to embodiments, a waypoint statechart object can be transitioned into multiple progress-tracking composite states, including a first composite state (e.g., the pending state 3202 of FIG. 3C) to computationally represent and/or model the service provider's progress in navigating to or arriving at the location associated with the waypoint statechart object and a second composite state (e.g., the waiting state of FIG. 3203 of FIG. 3C) to computationally represent and/or model the service provider's performance of tasks (e.g., picking up or dropping off the requesting user, retrieving or delivering items for a delivery order, etc.) at or near the location associated with the statechart object. And as illustrated in FIG. 3C, each of the composite states can have multiple substates that are transitioned into in response to the thresholds being met. And each of the composite states can include multiple failure substates such as a warning substate and a critical substate. The failure substates can each be associated with a respective failure threshold.

At step 4402-1, the network system can dynamically determine ETA thresholds, which can be used in monitoring the service provider's progress in the first composite state (e.g., the pending state 3202 of FIG. 3C) in navigating to or arriving at the location associated with the statechart object. Thus, in one aspect, an ETA threshold can represent an amount of delay in traveling towards a location the service provider can experience before the network system is triggered to perform compensatory or recovery actions. For example, if the network system determines (e.g., based on location data transmitted by the service provider's device) that the current ETA of the service provider to the location associated with the waypoint statechart object exceeds the ETA threshold, the waypoint statechart object can be transitioned into a failure substate, which can in turn trigger the performance of compensatory or recovery actions. In addition or as an alternative, the ETA threshold can be defined as a time delta from an initially-determined ETA (e.g., ETA determined at the time the route plan was created or at the time the waypoint statechart object was first instantiated).

The ETA thresholds can be dynamically determined by the network system based on the service provider's current location 4402-1A, map data 4402-1B, current traffic information 4402-1C, and route plan(s) 4402-1D. The route plan(s) 4402-1D can include the route plan of a first transport job that is linked to the waypoint statechart object of method 4400.

The route plan(s) 4402-1D can further include route plans associated other transport jobs statechart objects (e.g., transport jobs other than the first transport job). As a first example, the network system can determine the ETA thresholds of the composite state, including a first ETA threshold for triggering transition to a first failure substate and a second ETA threshold for triggering transition a second failure substate, based on information relating to a second transport job statechart object linked to the same fulfillment order as the first transport job. In this manner, the network system can determine the ETA thresholds relating to, for example, a location (e.g., a drop-off location) on a first segment of a multi-modal transport service based on the route plan for a second segment of the multi-modal transport. For example, the first segment can be a transport job provided by a service provider and the second segment can be a segment to be taken by the user on public transit. The ETA thresholds for drop-off location of the first segment can be dynamically determined based on information relating to the second segment (e.g., a scheduled departure time for the public transit segment). In doing so, the network system can compute the ETA thresholds as the latest determined time the service provider can be late in dropping of the requesting user at the drop off location of the first segment without affecting the remainder of the multi-modal transport. Moreover, the ETA thresholds can be updated based on real-time information relating to, for example, delays of the second segment (e.g., real-time schedule of departure of public transit service).

As another example, the route plan(s) 4402-1D can further include a route plan of a second fulfillment order or second transport job associated with the service provider. For instance, the service provider can contemporaneously fulfill multiple requests (e.g., multi-user rideshare transport, batched delivery of items to multiple requesting users, etc.) and ETA thresholds for a first waypoint associated with the fulfillment of a first request can be determined based, at least in part, on information relating to the service provider's fulfillment of the second request that is being contemporaneously fulfilled by the service provider. The service provider can also be identified to fulfill a second request immediately after completing the fulfillment of a first request. In this context too, ETA thresholds of the first waypoint can be determined, at least in part, on information relating to the service provider's fulfillment of the second request because failures or delays in the service provider's progression with respect to the first waypoint associated with the first request can directly lead to failures or delays with respect to the fulfillment of the second request.

At step 4402-2, the network system can dynamically determine wait time thresholds, which can be used in monitoring the service provider's progress in performing one or more tasks associated with the location associated with the statechart object while in the second composite state (e.g., the waiting state 3203 of FIG. 3C). The task tracked by the composite state depends on the location and on the type of service being rendered. For example, for a transport service, the tasks can include picking up and dropping off the requesting user and, for a delivery service, the tasks can include retrieving and delivering items. Thus, in one aspect, a wait time threshold can represent an amount of time a service provider can wait at the pickup location for a requesting user to rendezvous with and pick up the user before compensatory or recovery actions need to be performed. In another aspect, the wait time threshold can represent an amount of time the service provider can wait at a vendor or other entity to retrieve items request for delivery before compensatory or recovery actions need to be performed. Furthermore, in response to the statechart object transitioning to the composite state (e.g., the pending or waiting composite states), the network system can start one or more timers. Upon the one or more timers exceeding the wait time thresholds, the waypoint statechart object can be triggered to transition to a failure substate of the composite state (e.g., warning substate, critical substate).

In certain implementations, the wait time thresholds can be determined and/or updated based on the location data transmitted by the requesting user's device 4402-2A. For instance, in the context of a transport service, the wait time threshold associated with a waypoint statechart object representing the pickup location can be computed based at least in part on the user's location relative to the pickup location. In this manner, the network system can build in expected travel time of the requesting user to the pickup location when the route plan is determined and account for this travel time in the determination of the wait time threshold of the service provider at the pickup location. Thus, the transport service can flexibly account for such scenarios where the service provider may need to wait longer at the pickup location.

In another aspect, the wait time thresholds can be determined by the service type 4402-2B. For instance, a service provider providing a dedicated transport service may wait at the pickup location for the requesting user for a longer duration than another service provider providing a rideshare transport service. In other examples, the wait time thresholds can be determined and/or updated based on item preparation times 4402-2C. For instance, the network system can be configured, based on historical data and/or real-time data, forecast preparation times of items requested for delivery by the user. Furthermore, as described with respect to the determination of ETA thresholds 4402-1, the determination of the wait time thresholds can similarly be based on the route plans of other transport jobs or fulfillment orders associated with the service provider 4402-1D. In yet other examples, the wait time threshold can be determined based on the location associated with the waypoint statechart object 4402-2E. For instance, the wait time threshold of a pickup location can be adjusted lower based on the location being a busy intersection where extended wait times are not feasible.

At step 4403, the network system can monitor for and detect triggering event, which can correspond to one or more of the failure thresholds being reached and/or the occurrence of one or more triggering events. The network system can monitor, for example, updates to the location data 4403-1 of the service provider and can compute up-to-date ETA of the service provider to the location associated with the waypoint statechart object. If the up-to-date ETA exceeds either a first ETA threshold associated with the first failure substate (e.g., warning substate) or a second ETA threshold associated with the second failure substate (e.g., critical substate), the statechart object can be triggered to transition to the respective substate. In addition, the transition can be triggered by the expiration of the wait time timer(s) 4403-2 (e.g., wait time in excess of the wait time threshold(s) determined at step 4402-2).

According to embodiments, the network system can further detect an event triggering the transition of the statechart object to a failure substate based data received from the service provider device corresponding to inputs provided by the service provider via the service provider application 4403-3. For instance, in the context of a delivery service, the service provider can input, via the service provider application, that delivery of requested items at the delivery location cannot be performed (e.g., lack of access to the building, item must be delivered in person and the requesting user is not available to receive the items). This input can trigger the waypoint statechart object corresponding to the delivery location to transition into a failure substate. As another example, in the context of a transport service, a user input within the user application to alter the pickup location can trigger the waypoint statechart object that corresponds to the pickup location to transition into the critical state. In response, recovery actions can be taken at the transport job level to replace the failed waypoint statechart object with a newly created waypoint statechart object that corresponds to the updated pickup location selected by the user. More broadly, other service provider or user inputs and other contextual data can also trigger other statechart objects to transition to failed states. For instance, within the service provider application, the service provider can select to cancel an assigned transport job and this can trigger the failure of the transport job statechart object. As another example, the service provider can provide an input indicating that there has been an accident or a mechanical issue with the transport vehicle, and corresponding recovery actions can be taken. Furthermore, in the context of a delivery service, an entity (e.g., a restaurant) preparing an item for delivery can inform the network service that the item cannot be prepared. In response to receiving such information, the network system can trigger the transport job statechart object and/or the fulfillment statechart object to transition into a failure or partial failure state.

In addition to the aforementioned examples, triggering events can also be detected using sensor data generated by the provider device of the service provider and/or the user device of the requesting user. For example, traffic accidents involving the service provider's vehicle can be detected by way of monitoring sensor data (e.g., accelerometer data, audio data from microphone array, GPS data, etc.) generated by the provider device. In response to sensor data indicating, for example, a high probability of an accident, the statechart object can be triggered to transition to the critical substate.

At step 4404, the network system can determine the event type. If the detected event is that of a threshold associated with the warning substate being met (e.g., updated ETA to a location exceeding a first ETA threshold, wait time at the location exceeding a first wait time threshold), the statechart object can be triggered to transition to the warning substate at step 4405. In response to this transition, the one or more corresponding compensatory or recovery actions can be taken at step 4406. The network system can continue monitoring for and detecting for triggering events after triggering the statechart object to transition to the warning substate. For instance, the statechart object can transition from the warning substate to the on-track substate or to the critical substate based on detected events.

If the detected event is that of a threshold associated with the critical substate being met (e.g., updated ETA to the location exceeding a second ETA threshold, wait time at the location exceeding a second wait time threshold, the statechart object can be triggered to transition to the critical substate at step 4407. The transition of the statechart object such as a waypoint statechart object to the critical substate can trigger transitions of other statechart objects such as the transport job statechart object linked to the waypoint statechart object. The state transition of the transport statechart object can, in turn, trigger state transitions of other statechart objects (e.g., the fulfillment state chart object linked to the transport statechart objects). During state transitions triggered in this manner, information relating to the detected event (e.g., event type, time the event was detected, other contextual information relating to the event, etc.) can be conveyed during the triggering of the state transitions so as to relay the information through the hierarchy of statechart objects. Alternatively, such information can be stored in a database by, for example, the transaction coordinator 1035 of FIG. 1B. In this manner, the progress tracked by a waypoint statechart object can be made available at the transport job or the fulfillment order level and recovery actions can be taken at those hierarchy levels.

FIG. 4F is a flowchart diagram illustrating an example method of performing one or more recovery actions using linked statechart objects. Referring back to FIG. 4E, the portions of the method 4500 illustrated in FIG. 4F can correspond to aspects of the method 4400 discussed in FIG. 4E. For instance, step 4501 of FIG. 4F can correspond to or can be similar to step 4401 discussed with respect to FIG. 4E.

At step 4501, the network system can trigger a waypoint statechart object to be transitioned into a progress-tracking composite state such as the pending state or the waiting state. At step 4502, the network system monitors for and detects a triggering event. The triggering event can be a detected delay in the progress of the service provider in navigating towards the location of the This can be performed in a similar fashion as described in FIG. 4E with respect to step 4403. At step 4503, the network system determines whether the detected event constitutes a warning event or a critical event. In response to determining that the event is a warning event, the waypoint statechart object in question can be triggered to transition to the warning substate of the progress-tracking composite state at step 4504 and compensatory or recovery actions can be performed.

Compensatory actions for the waypoint statechart object transitioning into the warning substate can include transmitting notification data to the service provider 4504-1 and/or notification data to the requesting user 4504-2 to inform the service provider and/or the requesting user of the detected event such as a delay. The notification data 4504-1 and 4504-2 can cause the provider device and the user device to respectively present information such as the amount of detected delay. The notifications presented can include interactable features to cause the network system to perform one or more recovery actions. As one example, in the context of a transport service, in response to detecting a delay in the service provider's progress in navigating towards the pickup location, the network system can transit a set of notification data to the user device to cause the user device to present a notification that includes information relating to the delay and a selectable feature to cause the network system to re-perform matching for the user's request. In response to the user interacting with the selectable feature, the network system can unlink the service provider from the transport job and re-perform matching to identify another service provider for the user's request. As another example in the context of a multi-modal transport service, a detected delay in a first segment of the multi-modal transport service that is provided by a service provider can lead to a notification on the user device to give the user the option to rebook or reschedule a second segment of the multi-modal transport service (e.g., one that is provided by a public transit service). In response to the user selecting such an option, the network system can redetermine route plans for the transport job statechart objects in questions and update the statechart object hierarchy.

Furthermore, in response to the waypoint statechart object transitioning to the warning substate of the progress-tracking composite state, other failure thresholds for the waypoint statechart object and/or other waypoint statechart objects can be updated 4504-3. For instance, and again in the context of a transport service, in response to transitioning a waypoint statechart object corresponding to a pickup location to the warning substate of the pending composite state for tracking the progress of the service provider in navigating to the pickup location, wait time thresholds associated with the waiting composite state of that same waypoint statechart object can be adjusted. In one example, the wait time thresholds can be adjusted lower. This can be the case in a rideshare transport service in which the service provider must remain on schedule to contemporaneously provide service to multiple users and the adjustment can reflect that due to the delay in arriving at the pickup location, the service provider has less time to wait for the user at the pickup location.

If the event detected at steps 4502 and 4503 is a critical event (e.g., a critical ETA or wait time threshold being reached, etc.), the waypoint statechart object can be transitioned to the critical substate of the progress-tracking composite state at step 4505. This can indicate that the service provider is unable to perform the tasks (e.g., navigating to the location, picking up the user, delivering items, etc.) being tracked by the progress-tracking composite state or is unable to perform such tasks within an acceptable time window. In response to this state transition, an appropriate set of recovery actions can be retrieved and performed at the transport job level at step 4506. The recovery actions taken can include automatically (e.g., without requiring input or interaction from the user and/or the service provider) re-performing provider match to identify a new service provider 4506-1 in response to detecting the critical event and/or the waypoint statechart object transitioning to the critical substate. The network system can also remove the waypoint statechart object from the route plan and replace it with a new waypoint statechart object 4506-2. This can occur in response to a detected event corresponding to, for example, the user selecting a new pickup location after submitting the service request. In other examples, 4506-3, the route plan of the transport job statechart object can be updated, or alternatively, a new route plan of the transport statechart object can be created.

If no appropriate recovery actions to address the detected event can be found within the recovery actions available to the transport job statechart object, the transport job statechart object can transition into the failed state 4507. In response to such a transition, one or more recovery actions can be performed at the fulfillment order level at step 4508. As an alternative, information relating to the detected event can be passed to the fulfillment order statechart object if additional recovery actions are needed (e.g., at the fulfillment order statechart object level or at the transport provider statechart object level). In this manner, such additional recovery actions may be performed without the transport job statechart object transitioning to the failed state. Examples of recovery actions performed at the fulfillment order level (e.g., at step 4508) can include rescheduling one or more subsequent transport jobs associated with the same fulfillment order statechart object 4508-1, creating replacement transport statechart objects 4508-2, or updating other transport jobs associated with the same service provider 4508-3.

As one example, at step 4508-1, the network system can reschedule or other transport jobs associated with the same fulfillment order (e.g., another transport job linked to the same fulfillment order statechart object as the transport job that is in the critical substate). For instance, for a multi-legged or multi-modal transport request, a detected delay in a first leg of the trip (e.g., a first transport job) can cause the network system to reschedule a subsequent transport job(s). As part of the rescheduling of the subsequent transport job(s), service provider(s) associated with the subsequent transport job(s) can be re-identified based on the updated expected time of arrival or completion of the delayed transport job.

As another example, at step 4508-2, the network system can create a replacement transport job to replace the transport job that has failed (e.g., at step 4507). For example, in the course of fulfilling a transport job, the service provider can experience unrecoverable issues (e.g., an issue with a transport vehicle, a traffic accident, the service provider having to go offline, etc.). In such instances, the transport job statechart object associated with the failed transport job can be transitioned to the failed state (e.g., at step 4507). In response, the recovery actions can be taken at, for example 4508-2, in which the failed transport job can be disassociated from the fulfillment order statechart object and a replacement transport job statechart object can be instantiated. In the process of instantiating replacement transport job statechart object, another service provider can be identified. The locations (e.g., start location, destination location) of the replacement statechart object can be determined based on information associated with the failed transport job. For instance, the start location of the replacement transport job can be identified as the location of the incident that caused the existing transport job to fail (e.g., location of the traffic accident, location of the previous service provider when issues associated with the transport vehicle were experienced). As an alternative, the start location of the replacement statechart object can be identified using location data received from the user device of the requesting user. In this manner, should a transport job encounter an unrecoverable incident, a second service provider can be identified to transport the requesting user to the destination location. It should be appreciated that recovery actions under 4508-1 can be taken in conjunction with the creation of a replacement transport job statechart object. For instance, in the context of a multi-modal transport request, the rescheduling of a subsequent transport job 4508-1 can depend on the information relating to the replacement transport job (e.g., estimated time of arrival, etc.).

As yet another example, at step 4508-3, the network system can update other (e.g., future) transport job(s) associated with the service provider that is associated with the transport job experiencing delays. For instance, the service provider can be associated with a future transport job to provide transport to another user after completing an in-progress transport job. In such an instance, the detection of delays or errors experienced by the service provider in association with the in-progress transport job can trigger recovery actions to be performed for those future or scheduled transport job(s). As one example, in response to a first transport job statechart object—the first transport job statechart object being associated with a first fulfillment order statechart object and a first transport provider statechart object—transitioning to the critical sub-state, recovery actions can be performed with respect to a second transport job statechart object—the second transport job statechart object being associated with a second fulfillment order statechart object and the first transport provider statechart object. The recovery actions performed can be dependent on the expected delay of the first transport job. For instance, the second transport job statechart object can be triggered to transition into the warning or critical substates. In this manner, the same kinds of recovery actions as described herein with respect to FIGS. 4E and 4F can be undertaken for the second transport job, including transmission of notification messages to a second requesting user, identification of a replacement service provider for the second transport job, and the like.

At step 4509, if the fulfillment of the user's request will fail or partially fail, the fulfillment order statechart object can be triggered to transition to the failed state. This can, for example, cause all statechart objects linked, directly or indirectly, to the fulfillment order statechart object to be triggered into their respective failed or cancelled states.

Although hierarchical failure recovery using statechart objects having hierarchical or composite states has been described in FIGS. 4E and 4F with respect to waypoint statechart objects, such techniques can also be used in connection with other statechart object types in tracking the progress, delays, or failures in the fulfillment cycle of service requests. As one example, a procurement entity statechart object (e.g., 2190 of FIG. 2B) can be instantiated in connection with a service request for a delivery service for one or more requested items. The procurement entity statechart object can be transitioned to one or more composite states that monitor the status and progress of the preparation of the item(s) requested by the user for delivery. In this manner, the network system can manage other aspects of the delivery order (e.g., the transport-related aspects of the delivery order) based on the status and progress of the preparation of the requested item(s) (e.g., as represented by the state and/or state transitions of the procurement entity statechart object). For instance, based on real-time data from an entity represented by the procurement entity statechart object (e.g., a restaurant) indicating a delay in the estimated time of preparation of the requested items, the procurement entity statechart object can be transitioned to a warning and/or a critical substate. The relevant information relating to the delay can be passed to the procurement job statechart object (e.g., 2180 of FIG. 2B) and/or the fulfillment order statechart object (e.g., 2110 of FIG. 2B) and recovery actions can be taken. As one example, the transport job statechart object related to the procurement entity statechart object (e.g., transport job statechart object 2120 of FIG. 2B) can be modified to account for the detected delay. For instance, the transport job represented by the transport job statechart object 2120 can be re-scheduled (e.g., the dispatch time for the service provider can be delayed) in response to the procurement entity statechart object transitioning to the warning or critical substate. In addition or as an alternative, a different service provider can be identified based on the delay.

Hardware Diagrams

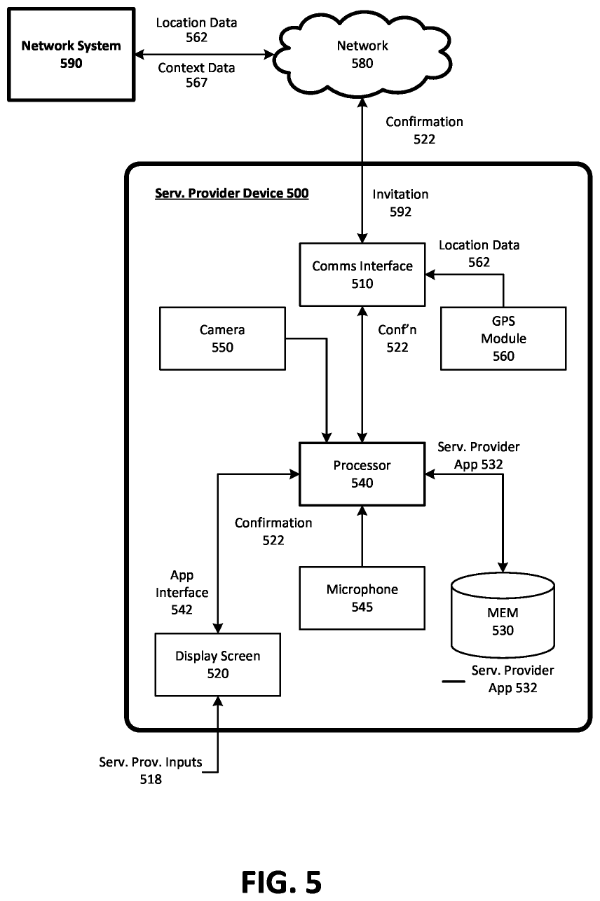

FIG. 5 is a block diagram illustrating an example service provider device executing and operating a designated service provider application for communicating with a network service, according to examples described herein. In many implementations, the service provider device 500 can comprise a mobile computing device, such as a smartphone, tablet computer, laptop computer, VR or AR headset device, and the like. As such, the service provider device 500 can include typical telephony features such as a microphone 545, a camera 550, and a communication interface 510 to communicate with external entities using any number of wireless communication protocols. The service provider device 500 can store a designated application (e.g., a service provider app 532) in a local memory 530. In response to a service provider input 518, the service provider app 532 can be executed by a processor 540, which can cause an app interface 542 to be generated on a display screen 520 of the service provider device 500. The app interface 542 can enable the service provider to, for example, accept or reject invitations 592 in order to service requests throughout a given region.

In various examples, the service provider device 500 can include a GPS module 560, which can provide location data 562 indicating the current location of the service provider to the network system 590 over a network 580. Thus, the network system 590 can utilize the current location 562 of the service provider to determine whether the service provider is optimally located to service a particular request. If the service provider is optimal to service the request, the network system 590 can transmit an invitation 592 to the service provider device 500 over the network 580. The invitation 592 can be displayed on the app interface 542, and can be accepted or declined by the service provider. If the service provider accepts the invitation 592, then the service provider can provide a service provider input 518 on the displayed app interface 542 to provide a confirmation 522 to the network system 590 indicating that the service provider will rendezvous with the requesting user at the start location to service the ride request.

In certain implementations, the service provider device 500 is configured to generate and transmit, to the network system 590, context data 563 that can be used by the network system to determine a propensity of the service provider who operates the service provider device 500 to perform an action via the service provider application 532. The context data 563 can include service provider application interaction data indicating interactions or inputs of the service provider with the service provider application 532. The context data 463 can further include sensor data such accelerometer data, gyroscope data, e-compass data, and the like. In certain implementations, the network system 590 can further utilize location data 562 as context data in making certain determinations. Using the context data 563, the network system 590 can determine, using one or more context models, a propensity of the service provider to, for example, decline an invitation corresponding to a service request form a user or cancel an acceptance after the service provider has accepted the invitation.

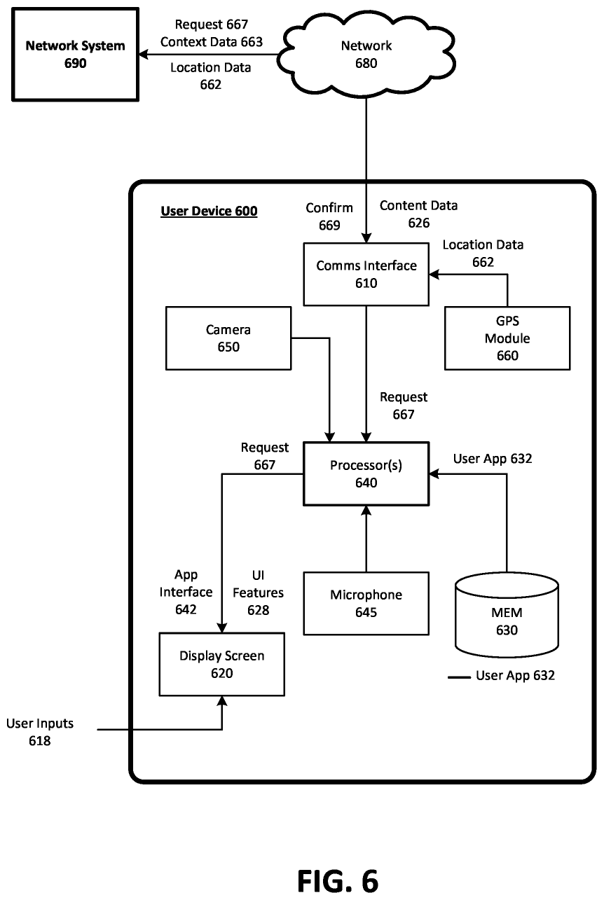

FIG. 6 is a block diagram illustrating an example user device executing and operating a designated user application for communicating with a network system, according to examples described herein. In many implementations, the user device 600 can comprise a mobile computing device, such as a smartphone, tablet computer, laptop computer, VR or AR headset device, and the like. As such, the user device 600 can include typical telephony features such as a microphone 645, a camera 650, and a communication interface 610 to communicate with external entities using any number of wireless communication protocols. In certain aspects, the user device 600 can store a designated application (e.g., a user application 632) in a local memory 630. In variations, the memory 630 can store additional applications executable by one or more processors 640 of the user device 600, enabling access and interaction with one or more host servers over one or more networks 680.

In response to a user input 618, the user application 632 can be executed by a processor 640, which can cause an application interface 642 to be generated on a display screen 620 of the user device 600. The application interface 642 can enable the user to, for example, check current value levels and availability for the network service. In various implementations, the application interface 642 can further enable the user to select from multiple service types.

The user can generate a service request 667 via user inputs 618 provided on the application interface 642. For example, the user can select a start location, view the various service types and estimated costs, and select a particular service to an inputted destination. In many examples, the user can input the destination prior to pick-up. As provided herein, the user application 632 can further enable a communication link with a network system 690 over the network 680, such as the network system 100 as shown and described with respect to FIG. 1. The processor 640 can generate user interface features 628 (e.g., map, trip progress bar, content cards, etc.) using content data 626 received from the network system 690 over network 680. Furthermore, as discussed herein, the user application 632 can enable the network system 690 to cause the generated user interface features 628 to be displayed on the application interface 642.

The processor 640 can transmit the service requests 667 via a communications interface 610 to the backend network system 690 over a network 680. In response, the user device 600 can receive a confirmation 669 from the network system 690 indicating the selected service provider and vehicle that will fulfill the service request 667 and rendezvous with the user at the start location. In various examples, the user device 600 can further include a GPS module 660, which can provide location data 662 indicating the current location of the requesting user to the network system 690 to, for example, establish the start location and/or select an optimal service provider or autonomous vehicle to service the request 667.

In certain implementations, the user device 600 is configured to generate and transmit, to the network system 690, context data 663 that can be used by the network system to determine a propensity of the user who operates the user device 600 to perform an action via the user application 632. The context data 663 can include user application interaction data indicating interactions, inputs, selections, or a degree of progress through a particular user interface flow (e.g., a user interface flow to submit a service request). The context data 663 can further include sensor data such as barometer or elevation data, ambient light sensor data, accelerometer data, gyroscope data, location data 662, and the like. The context data 663 can further include user application status data indicating, for example, whether the user application 632 is executing as a background process or as a foreground process on the user device 600. The user application status data can further indicate a duration of time the user application 632 has been executing as a foreground process or a duration of time the user application 632 has been executing as a background process. Using the context data 663, the network system 690 can determine, using one or more context models, a propensity of the user to, for example, submit a service request within the next 2 minutes, or cancel a submitted service request 667 once the user is matched by the network system 690 with a service provider in response to the service request 667.

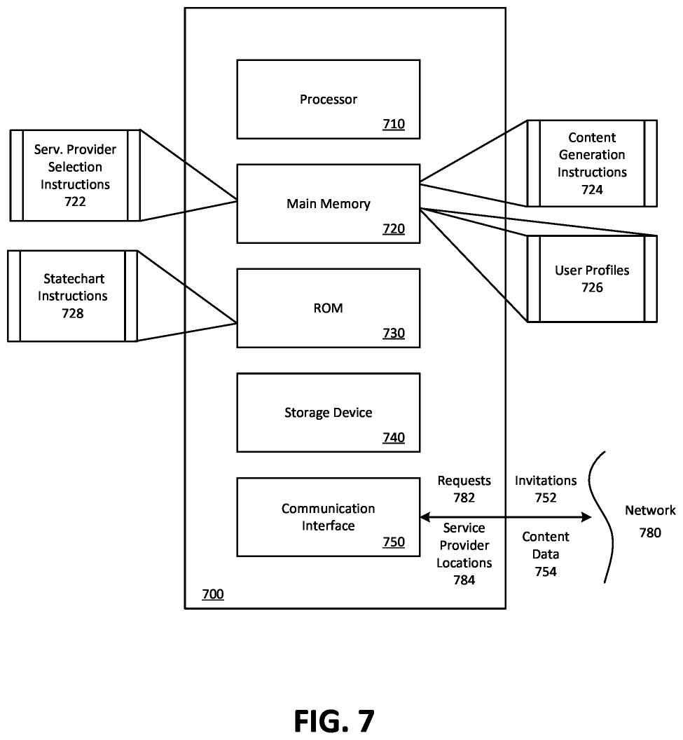

FIG. 7 is a block diagram that illustrates a computer system upon which examples described herein may be implemented. A computer system 700 can be implemented on, for example, a server or combination of servers. For example, the computer system 700 may be implemented as part of a network service, such as described in FIGS. 1 through 6. In the context of FIG. 1, the computer system 700 may be implemented using a computer system 700 such as described by FIG. 6. The network system 100 may also be implemented using a combination of multiple computer systems as described in connection with FIG. 7.

In one implementation, the computer system 700 includes processing resources 710, a main memory 720, a read-only memory (ROM) 730, a storage device 740, and a communication interface 750. The computer system 700 includes at least one processor 710 for processing information stored in the main memory 720, such as provided by a random access memory (RAM) or other dynamic storage device, for storing information and instructions which are executable by the processor 710. The main memory 720 also may be used for storing temporary variables or other intermediate information during execution of instructions to be executed by the processor 710. The computer system 700 may also include the ROM 730 or other static storage device for storing static information and instructions for the processor 710. A storage device 740, such as a magnetic disk or optical disk, is provided for storing information and instructions.

The communication interface 750 enables the computer system 700 to communicate with one or more networks 780 (e.g., cellular network) through use of the network link (wireless or wired). Using the network link, the computer system 700 can communicate with one or more computing devices, one or more servers, and/or one or more self-driving vehicles. In accordance with examples, the computer system 700 receives requests 782 from mobile computing devices of individual users. The executable instructions stored in the memory 730 can include service provider selection instructions 722, which the processor 710 executes to select a service provider to service the request 782. In doing so, the computer system can receive service provider locations 784 of service providers operating throughout the given region, and the processor can execute the service provider selection instructions 722 to identify a plurality of candidate service providers and transmit invitation messages 752 to each of the candidate service providers to enable the service providers to accept or decline the invitations. The processor can further execute the service provider selection instructions 722 to select a service provider among interested candidate service providers to service the request 782.

The executable instructions stored in the memory 720 can also include content generation instructions 724, which enable the computer system 700 to access user profiles 726 and other user information in order to select and/or generate user content 754 for display on the user devices. As described throughout, user content 754 can be generated based on information pertaining to the state of the request (e.g., ETA/destination info). In addition, instructions executed by the processor 710 can further include statechart instructions 728 that pertain to the instantiation, maintenance, and state transitions of statechart objects as described herein. By way of example, the instructions and data stored in the memory 720 can be executed by the processor 710 to implement an example network system 100 of FIG. 1. In performing the operations, the processor 710 can receive requests 782 and service provider locations 784, and submit invitation messages 752 to facilitate the servicing of the requests 782. The processor 710 is configured with software and/or other logic to perform one or more processes, steps and other functions described with implementations, such as described by FIGS. 1 and 2, and elsewhere in the present application.

Examples described herein are related to the use of the computer system 700 for implementing the techniques described herein. According to one example, those techniques are performed by the computer system 700 in response to the processor 710 executing one or more sequences of one or more instructions contained in the main memory 720. Such instructions may be read into the main memory 720 from another machine-readable medium, such as the storage device 740. Execution of the sequences of instructions contained in the main memory 720 causes the processor 710 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A network system comprising:
one or more processors; and
one or more memory resources storing instructions that, when executed by the one or more processors of the network system, cause the network system to:
receive, from a requester device of a requesting user, a request for a service, the request identifying a first location;
instantiate a first statechart object associated with the first location, the first statechart object capable of being transitioned into a plurality of composite states, including a first composite state for tracking a first progress of a service provider with respect to traveling to the first location and a second composite state for tracking a second progress of the service provider with respect to performing one or more tasks at the first location;
while first statechart object is in a first substate of the first composite state, trigger the first statechart object to transition to a second substate of the first statechart object based on a first set of data received from a provider device of the service provider or from the requester device; and
in response to the first statechart object transitioning to the second substate of the first composite state, perform a set of recovery functions.

2. The network system of claim 1, wherein the first set of data received from the provider device is a set of input data generated by the provider device in response to an input provided by the service provider via a service provider application executing on the provider device or by the requester device in response to an input provided by the requesting user via a user application executing on the requester device.

3. The network system of claim 1, wherein the first set of data received from the provider device is a first set of location data; and
wherein triggering the first statechart object to transition to the second substate of the first statechart object comprises: (i) determining, based on the set of location data, a first estimated time of arrival (ETA) of the service provider at the first location, and (ii) in response to determining that the first ETA exceeds a first threshold value, triggering the first statechart object to transition to the second substate of the first composite state.

4. The network system of claim 3, while the first statechart object is in the second substate of the first composite state, determining a second ETA of the service provider at the first location and, in response to determining that the second ETA exceeds a second threshold value, triggering the first statechart object to transition to a third substate of the first composite state.

5. The network system of claim 1, wherein the set of recovery functions includes one or more of: (i) transmitting a first set of data to cause a first notification to be presented on the requester device, the first notification displaying information relating to an ETA of the service provider at the first location, (ii) transmitting a set of data to cause a second notification to be presented on the provider device, the second notification requesting an input from the service provider, (iii) updating one or more threshold values used in determining whether to trigger a state transition of the first statechart object or another statechart object, (iv) identifying a second service provider to fulfill the request for the service instead of the service provider, (v) replacing the first location with a second location and instantiating a second statechart object for the second location, or (vi) updating a route plan of the service provider.

6. The network system of claim 1, wherein the set of recovery functions includes transitioning a second statechart object to a failed state, the second statechart object being linked to the first statechart object.

7. The network system of claim 6, wherein the executed instructions further cause the network system to perform, in response to the second statechart object transitioning to the failed state, a second set of one or more recovery functions.

8. The network system of claim 1, wherein the service is a transport service and the first location corresponds to either a pickup location where the service provider is to rendezvous with the requesting user or a destination location where the service provider is to drop off the requesting user.

9. The network system of claim 1, wherein the service is a delivery service and the first location corresponds to either an item pickup location or an item drop-off location.

10. A network system comprising:
one or more processors; and
one or more memory resources storing instructions that, when executed by the one or more processors of the network system, cause the network system to:
receive, from a requester device of a requesting user, a request for a service, the request identifying a first location;
instantiate a first statechart object associated with the first location, the first statechart object capable of being transitioned into a plurality of composite states, including a first composite state for tracking a first progress of a service provider in traveling to the first location and a second composite state for tracking a second progress of the service provider in performing one or more tasks at the first location;
while the first statechart object is in the first substate of the second composite state, monitor a wait time associated with the second progress of the service provider in performing one or more tasks at the first location;
in response to the wait time exceeding a threshold value, trigger the first statechart object to transition to a second substate of the second composite state; and
in response to the first statechart object transitioning to the second substate of the second composite state, perform a set of recovery functions.

11. The network system of claim 10, wherein the executed instructions further cause the network system to, while the first statechart object is in the first composite state, trigger the first statechart object to transition to the first substate of the second composite state based on location data received from a provider device of the service provider.

12. The network system of claim 11, wherein triggering the first statechart object to transition to the first substate of the second composite state based the location data received from the provider device further comprises triggering the first statechart object to transition to the first substate of the second composite state based on the location data indicating that the service provider is within a distance of the first location.

13. The network system of claim 10, wherein the executed instructions further cause the network system to, in response to the first statechart object transitioning to the first substate of the second composite state, begin a timer.

14. The network system of claim 13, wherein monitoring the wait time associated with the second progress of the service provider in performing one or more tasks at the first location comprises determining whether the timer has exceeded the threshold value.

15. The network system of claim 10, wherein the one or more tasks at the first location corresponds to one of: (i) picking up the requesting user at a pickup location, (ii) dropping off the requesting user at a destination location, (iii) retrieving one or more items for delivery at an item pickup location, or (iv) delivering one or more items for delivery at an item delivery location.

16. The network system of claim 10, wherein the one or more recovery actions include one or more of: (i) transmitting a first set of data to cause a first notification to be presented on the requester device, the first notification displaying information relating to an ETA of the service provider at the first location, (ii) transmitting a set of data to cause a second notification to be presented on the provider device, the second notification requesting an input from the service provider, (iii) updating one or more threshold values used in determining whether to trigger a state transition of the first statechart object or another statechart object, (iv) identifying a second service provider to fulfill the request for the service instead of the service provider, (v) replacing the first location with a second location and instantiating a second statechart object for the second location, or (vi) updating a route plan of the service provider.

17. The network system of claim 10, wherein the set of recovery functions includes transitioning a second statechart object to a failed state, the second statechart object being linked to the first statechart object.

18. The network system of claim 17, wherein the executed instructions further cause the network system to perform, in response to the second statechart object transitioning to the failed state, a second set of one or more recovery functions.

19. A network system comprising:
one or more processors; and
one or more memory resources storing instructions that, when executed by the one or more processors of the network system, cause the network system to:
receive, from a requester device of a requesting user, a request for a service, the request identifying a first location;
instantiate a first statechart object associated with the first location, the first statechart object capable of being transitioned into a plurality of composite states, including a first composite state for tracking a first progress of a service provider with respect to traveling to the first location and a second composite state for tracking a second progress of the service provider with respect to performing one or more tasks at the first location;
while in a first substate of the first composite state, monitor location data transmitted by a provider device of the service provider to determine whether to trigger the first statechart object to transition to: (i) a first substate of the second composite state, or (ii) a second substate of the first composite state and perform a first set of one or more recovery functions; and
while in the first substate of the second composite state, determine whether to trigger the first statechart object to transition to a second substate of the second composite state and perform a second set of one or more recovery functions.

20. The network system of claim 19, wherein the first set of one or more recovery functions and the second set of one or more recovery functions each includes triggering a second statechart object to transition to a failed state, the second statechart object being linked to the first statechart object, and wherein the executed instructions further cause the network system to perform a third set of one or more recovery functions in response to the second statechart object transitioning to the failed state.
